(19) United States
(12) Patent Application Publication
(10) Pub. No.: US 2014/0200897 A1
(43) Pub. Date: Jul. 17, 2014

(54) MULTIMEDIA KEEPSAKES AND METHOD AND SYSTEM FOR THEIR MANUFACTURE

(71) Applicant: Geoffrey S. Stern, Westport, CT (US)

(72) Inventor: Geoffrey S. Stern, Westport, CT (US)

(21) Appl. No.: 13/740,079

(22) Filed: Jan. 11, 2013

(51) Int. Cl. G10L 21/00

(52) U.S. Cl. CPC G10L 21/00
USPC 704/272

(57) ABSTRACT

An audio or multimedia unit is provided which may be attached to or mounted within an existing book. In a record mode of operation, it permits a user to select a particular page of the book and record audio or multimedia information relative to that page. In a playback mode of operation the user may select any page and play back audio or multimedia previously recorded with respect to that page.

The present patent application claims the benefit of the filing dates of Provisional Patent Application No. 61/585,429 filed Jan. 11, 2012 and Provisional Patent Application No. 61/699,854 filed Sep. 11, 2012. The content of both of these patent applications is hereby incorporated by reference in its entirety.

### BACKGROUND OF THE INVENTION

The present invention relates generally to multimedia keepsakes, and more particularly, concerns multimedia keepsakes, such as physical and electronic greetings, albums, and the like, and their manufacture.

Modern life finds family members and loved ones often separated by great distances. Modern technology has made communication very convenient, and toll-free telephone numbers and online order-taking services have made gift purchasing very convenient, especially when the recipient is far away. However, it has also resulted in gift giving having lost much of its personal, creative and romantic aspects. The modern gift giver may never touch or even see the gift he sends. The gift may be selected from a catalog or online, or flowers may be ordered from the group of “standard” arrangements. Also, a personal message delivered by a gift giver may be written by a retailer on a stock card and delivered by a total stranger. The desire to restore the excitement and personal involvement in giving a gift, without reintroducing all of the inconveniences eliminated by modern technology has resulted in some improvement of the process.

For example, in my own U.S. Pat. No. 5,425,078, I disclosed a voice message keepsake system which permitted use of a mailbox system to record a personal voice message which could then be accessed by a vendor, in any location, and recorded on an electronic keepsakes for playback, as desired. The keepsakes would then be included by the vendor, for example, with a gift, making it very personal.

Technological development since that time has made instantaneous, online, multimedia electronic communication possible and has opened vast possibilities for the creation of multimedia keepsakes. Smart telephones and PDAs, and the like, and wireless network communications have also made it possible to communicate with others from virtually any location and to virtually any location. However, little advantage has been taken of this technology to provide and improve multimedia keepsakes and their communication.

### SUMMARY OF THE INVENTION

In accordance with one aspect of the present invention, a multimedia keepsake and the system for its production are provided. At a kiosk, or using any form of computerized network communication (e.g. a PDA), a gift giver may design a multimedia keepsakes in a processor. It may include any or all of a personal image, a text message, and an audio recording, including a voice message, although these may originate with the gift giver and be uploaded to the processor. The processor then assembles the multimedia keepsake under the gift giver's control.

For convenience of description, reference is made herein to a “gift giver.” However, it will be appreciated that a person may often be creating a multimedia keepsake for himself.

The multimedia keepsake may be a physical one or an electronic one. In one embodiment, the keepsake is a multimedia greeting card. The gift giver selects a card form or template, creates a text message, and provides a voice and/or music recording and an image. At a kiosk, the text message and image are placed upon the card form by a local printer and the audio is recorded on a small electronic circuit board by a local recorder hidden in an appropriate compartment in the card (or affixed thereto). Pressing a marked location or opening on the card causes the audio recording to be played back. If the gift giver is working online, the processor may be virtually anywhere where Internet communication is available. Files representing the completed keepsake are stored in storage available to the processor, which storage may be accessed online in order to produce the completed keepsake at an order filling location. Alternately, the gift giver could go to a local kiosk and complete the physical keepsake.

It is also contemplated that the keepsake may be in the form of an album or book containing a plurality of visual keepsakes. In this case, one or more separate, touch sensitive visual keepsakes may be provided within each of the pages and linked to electronics embedded in the cover. One or more audio recordings associated with each visual keepsake would be recorded in the electronics, and the appropriate recording(s) would be played, depending upon the keepsake which is touched.

In accordance with another aspect of the invention, the keepsake is an electronic form and may be communicated electronically. As was the case with a physical keepsake, the gift giver provides an image, a text message, and an audio recording in electronic form. The images recorded in a standard format, such as a JPEG file, and use is made of Exif metadata tags to embed the text and audio file within the image file. In this manner, the gift giver can communicate a single file representing the entire multimedia keepsake. The gift recipient, upon opening the image file will see the text message thereon, and the audio file is played back. Although this can be accomplished by providing appropriate plug-ins to conventional image editing software and conventional image viewing software (e.g. a web browser). It is also contemplated that conventional album-creating software could be used to store the images by providing appropriate plug-ins to permit the production of multimedia albums.

In accordance with another aspect of the invention, a page of an album containing photographs may be provided with touch sensitive areas, so that a viewer may touch such areas and hear prerecorded sound recordings related to the photograph. Touch sensors are preferably embedded in a cover of the album and aligned indicia are provided on an album page.

In accordance with another aspect of the invention, an audio unit is provided which may be attached to an existing book. In a record mode of operation, it permits a user to select a particular page of the book and record audio information relative to that page. In a playback mode of operation the user may select any page a play back audio previously recorded with respect to that page.

### BRIEF DESCRIPTION OF THE DRAWINGS

The foregoing brief description and further objects, features and advantages of the present invention will be understood more completely from the following detailed description of presently preferred, but nonetheless illustrative, embodiments in accordance with the present invention, with reference being had to the accompanying drawings in which:

FIG. 1 is schematic block diagram illustrating a system 10 for generating multimedia greeting, which incorporates objects and features of the present invention;

FIG. 2, is a flowchart illustrating a preferred method used in the system 10 to generate the multimedia greeting card;

FIG. 3 is a schematic diagram illustrating a preferred record/playback device 110 in accordance with the present invention;

FIG. 4 is a functional block diagram of a preferred integrated circuit used in the device 110 of FIG. 3;

FIG. 5 is a block diagram of an album of talking photographs and/or photographs accompanied by audio, in accordance with the present invention;

FIG. 6 is a schematic diagram of a preferred interface unit for use between a voice recording device and circuit board CB;

FIG. 7 is a perspective view of a photographic album 70 embodying the present invention, shown in its closed position;

FIG. 8 is a perspective view of the album 70 shown in its open position;

FIG. 9 is an exploded view of the photographic album 70 of FIGS. 7 and 8;

FIG. 10 is a perspective view of a multimedia greeting card 150 embodying the present invention;

FIGS. 11 (A), (B), and (C) are rear, side, and front views, respectively, of circuit a board 160 used in greeting card 150;

FIG. 12 is schematic block diagram illustrating an exemplary system 10′ for generating a multimedia keepsake with multiple pages, such as an album;

FIG. 13 is a functional block diagram illustrating the top level of operation of system 10′;

FIG. 14. is a functional block diagram illustrating the operation of the page editing process 210;

FIG. 15 is a functional block diagram illustrating the preferred operation for album creation process 212;

FIG. 16 is a functional block diagram illustrating a preferred method for creating a multimedia album from a recorded video.

FIG. 17 is a perspective view of an audio unit 710, embodying the invention, in use with an existing book A;

FIG. 18 is a view of the rear of the book A, showing audio unit 710 thereon;

FIG. 19 is a perspective left side view of audio unit 710, shown with clip 712 detached;

FIG. 20 is a top view of audio unit 710, similarly shown with clip 712 detached;

FIG. 21 is a block diagram illustrating the electronic structure of audio unit 710; and

FIGS. 22-30 are perspective views of book units embodying the present invention.

### DETAILED DESCRIPTION OF THE PREFERRED EMBODIMENTS

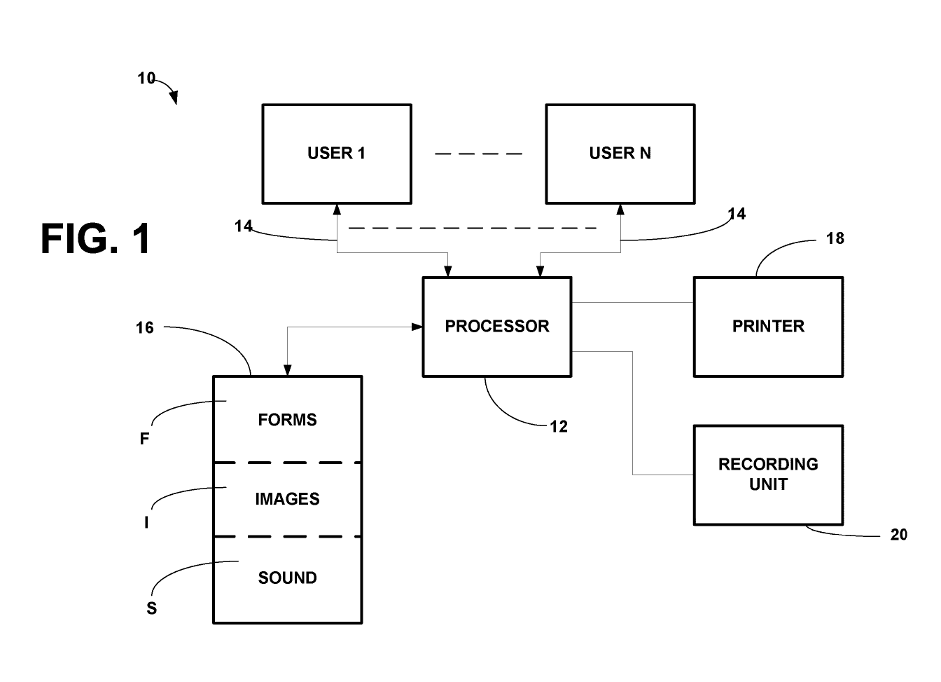

Turning now to the details of the drawings, FIG. 1 is schematic block diagram illustrating a system 10 for generating multimedia greeting, which incorporates objects and features of the present invention. It is contemplated that system 10 may be an online system, or it may be a kiosk at some central location. System 10 includes a processor 12 which accommodates a plurality of users U₁ . . . Uₙ, each connected to processor 12 via a communication link 14. The users communicate over links 14 via a communication device, such as a smart phone, a PDA, a terminal or a computer.

In an online system, processor 12 could be a server and the users' communication devices could be clients communicating with the server over a network, such as the Internet. Each communication link 14 could therefore be a fairly complex combination of communication media. In a kiosk, system 10 could be far simpler, with the uses communicating with processor 12 via simple terminals connected, for example, by a wire connection.

In storage 16, processor 12 has access to a collection of greeting forms F, a collection of images I and a collection of sounds S. The collection of images I may include images uploaded to the server by a user, such as personal photographs, and the collection of sounds S may include music and/or voice recordings (e.g. a personal message) uploaded by a user. The collection of forms F is preferably prepared by professionals, but it is contemplated that a user may be able to upload forms, as well.

Processor 12 also controls one or more printers 18 and one or more recording units 20. Preferably, the greeting is a printed greeting, such as a greeting card, in which case it to would include a flat substrate, such as a card material, upon which a selected image and/or a printed greeting may be produced via one of the printers 18. An electronic record/playback device, discussed further below, is embedded in the substrate, or provided in a pocket therein. The recording units 20 may be controlled by a user, through processor 12, to record music and/or a personal voice message, or any other audio, thereon.

An additional possibility is that a karaoke facility be provided which would permit the user to sing a song and be accompanied by prerecorded music. In addition, the user may be offered the opportunity to have the message recorded by a professional, for example a celebrity or a cartoon character. In this case, the user could type in his message and the recorded voice message would be created through a text-to-speech processor in the voice of the professional. Alternately, pre-recorded phrases in a professional's voice could be assembled into a customized message based upon the user's responses to a series of queries. This could also be accomplished by making use of concatenated text-to-speech technology (see www.varitalk.com).

In a kiosk, printers 18 and recording units 20 would typically be in close proximity to processor 12. A user, working at a terminal, could design and compose the greeting, and record a voice message and/or choose music. The greeting card is then printed on a printer 18 and, on a recording unit 20, a recordable electronic record/playback device (e.g., in the form of a small circuit card) is recorded and dispensed. The greeting is then completed by assembling the device to the card. Alternately, the order for a keepsake could merely be created at a kiosk and then forwarded to a fully equipped fulfillment center for manufacture of the keepsake. The completed keepsake could then be delivered to the kiosk for pickup by the user or shipped to the user's home. As a further alternative, a user could design and compose the greeting online as explained below and store all the information in a storage location accessible to processor 12. Subsequently, he could access that information from a kiosk, which also has access to the storage location, and complete the greeting card at the kiosk.

It is also contemplated that a user could be provided with specialized software for his computer or at a website (see www.mypublisher.com and www.shutterfly.com). Such software guides the user through the product design process, creating appropriate data files in the process. Those files are then transmitted to a fulfillment center for manufacture of the keepsake.

In an online system, a user may be remote and may even be communicating with processor 12 wirelessly. Under these circumstances, information representing the greeting card and the recorded sound information could be stored in a storage location accessible to processor 12. The printers 18 and/or the recording units 20 could also be remote from processor 12 and printing of the audio enhanced image and recording of the sound recording could take place at a fulfillment center and then be mailed or delivered to the recipient. The fulfillment center could also be co-located with the seller of a gift that is to accompany the greeting.

Alternately, with either the online system or a kiosk, the gift giver may wish to record a message in the privacy of his home. In this case, the customized image and text of the keepsake could be completed, but it would be provided with a record button, so that the gift giver could record a voice message on the completed keepsake.

It is also contemplated that the gift giver may wish provide an additional gift. In this case the keepsake could have a detachable portion constituting a stored value card, or the stored value card could be provided in a pocket of the keepsake, could be removeably attached to the keepsake or could be provided ins a common envelope with the keepsake.

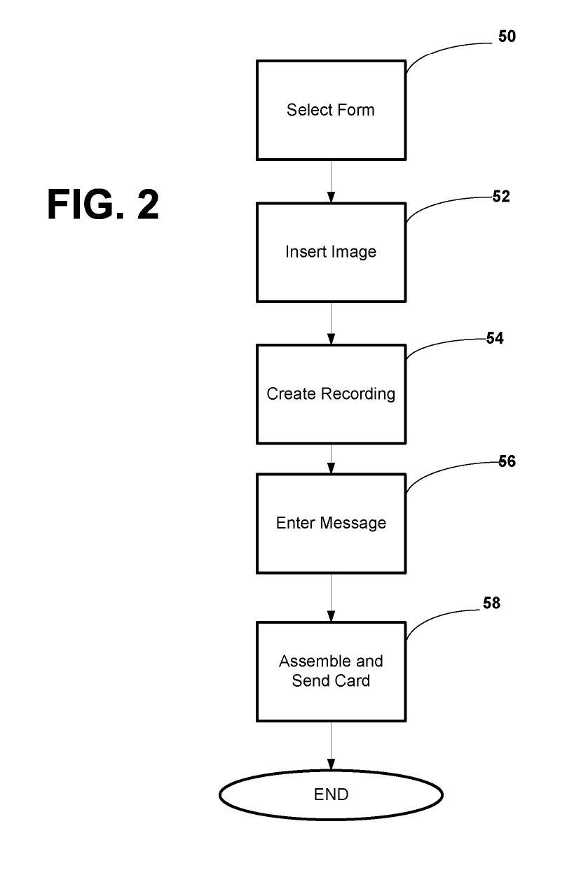

The operation of system 10 will be described with the aid of FIG. 2, which is a flowchart illustrating a preferred method used in the system 10 to generate the multimedia greeting card. Communicating with processor 12, a user selects a greeting card from the collection F (block 50), selects an image from the collection I (Block 52), and creates a sound recording from the collection S (Block 54). If the user wishes, he may then create a personal message (Block 56). At that point, the user has generated all the information necessary to produce a physical greeting card, and he may do so by any of the methods already described (block 58).

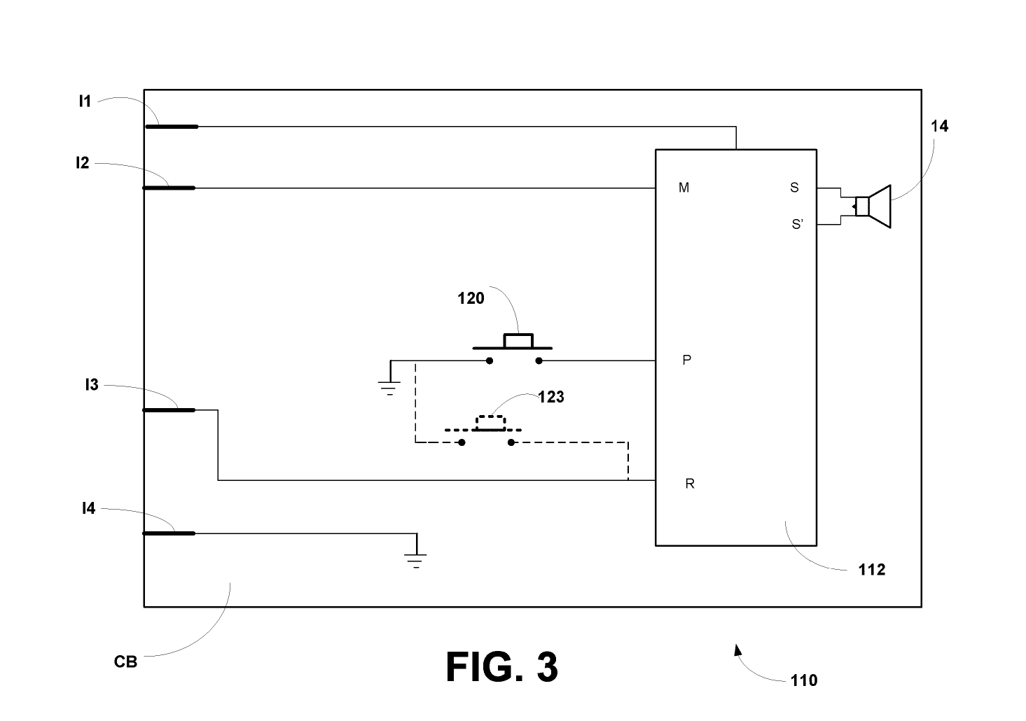

FIG. 3 is a schematic diagram illustrating a preferred record/playback device 110 in accordance with the present invention. Device 110 is preferably formed on a miniature printed circuit board CB, which is small enough and thin enough to be embedded in a pocket formed in a conventional greeting card or affixed thereto. At the heart of the device 110 is an integrated circuit 112 which performs the record/playback function. Circuit 112, a flat, miniature battery, and a piezoelectric speaker 114 are mounted on the circuit board. An input connection I1 is provided on board CB to a microphone input M on circuit 112. Circuit 112 also has a play input P which is grounded through a pushbutton 120 (it may also be a slide switch operated automatically when the card is opened). A record input connection I3 is connected to a record input R in circuit 112, and a speaker 122 is connected between outputs S and S′ of circuit 112. Board CB also has a connection I1 providing a power supply voltage and a connection 14 providing an external ground connection. Preferably, connections I1, I2, I3 and I4 are connections formed at the edge of board CB and may be contacted by an edge connector. As shown in phantom in FIG. 3, a second pushbutton 123 may be provided to permit manual recording of an audio signal.

Integrated circuit 112 is preferably an ISD1810 ChipCorder® available from Windbond Electronics Corporation America of San Jose, Calif. The device is a single message, single chip, record/playback circuit with selectable durations from 6.6 to 40 seconds. It is a CMOS device which includes an on-chip oscillator, microphone preamplifier, automatic gain control, anti-aliasing filter, a solid-state analog storage array, a smoothing filter, and a PWM class D speaker amplifier.

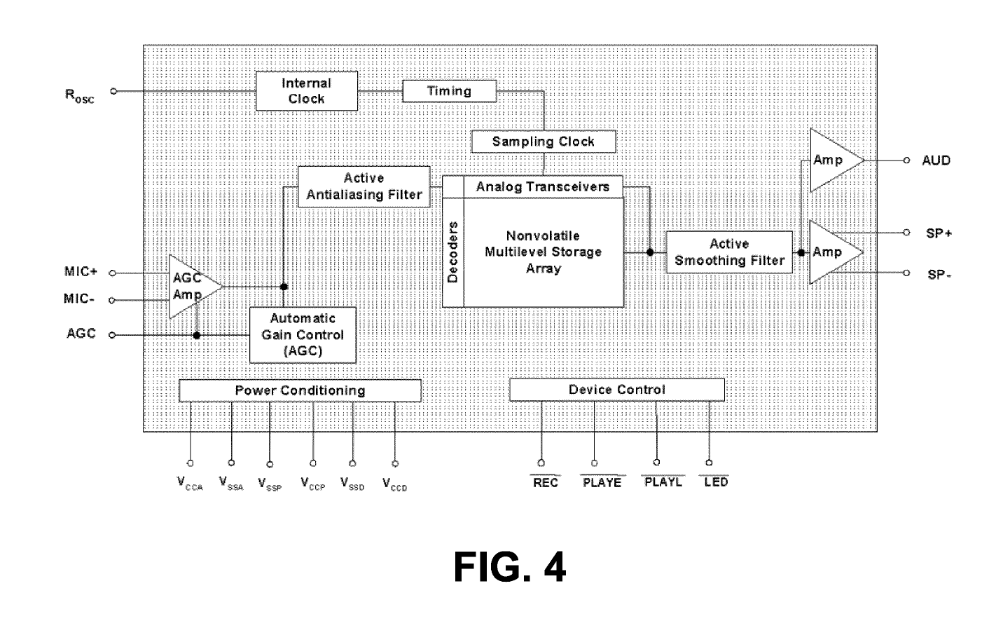

FIG. 4 is a functional block diagram of an ISD1810 integrated circuit. Negative and positive inputs are provided for differential connection of microphone or a microphone and a reference. It is also possible to provide to an analog line signal between these two inputs. The applied signal is subjected to automatic gain control (AGC) and is then applied to a nonvolatile multilevel storage array through an anti-aliasing filter. In this array, the signals are stored in analog form. A signal stored in the array is processed by a smoothing filter before being amplified, to produce a speaker drive signal between the outputs SP+ and SP−. Applied power supply voltages are subjected to power condition, and control inputs are available for recording (REC) and two types of playback, edge-triggered playback (PLAYE) and level-triggered playback (PLAYL).

The integrated circuit is comprised of flash memory cells, so messages can be stored without the use of power. Since storage is analog, audio data can be stored directly and memory in its natural form, without a compression, as is the case with digital audio. This provides high-quality, solid-state audio reproduction, with a minimum power consumption.

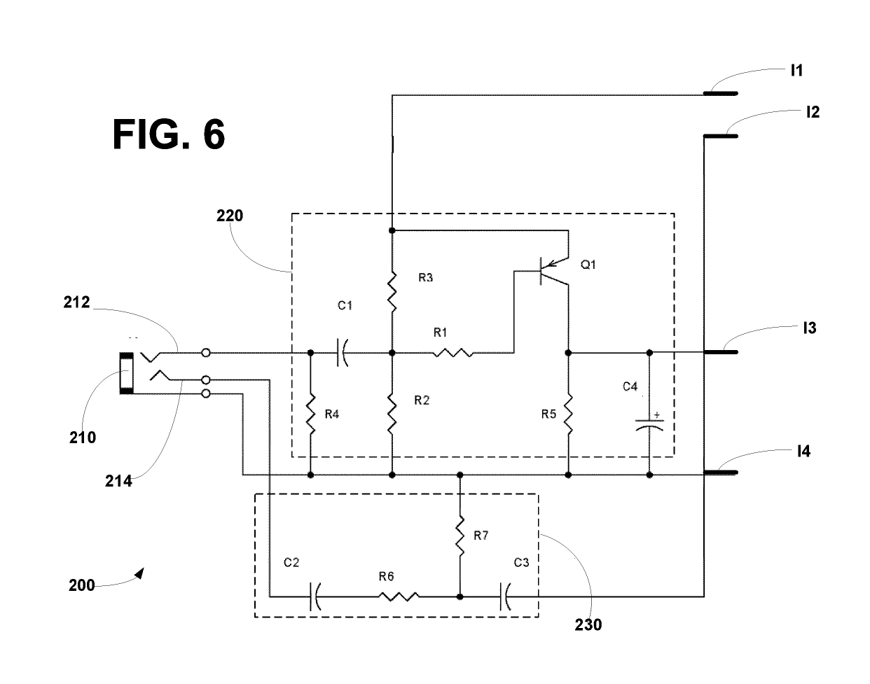

Circuit 112 has a single monaural input. Preferably, circuit 112 is recorded by a recorder 28, which includes a stereo sound recorder (not shown) that receives the original audio signal and an interface unit 200 (see FIG. 6). In practice, only one of the stereo recorder channels is used for audio recording. The other channel is pre-recorded with a high pitched tone of predetermined frequency. This is accomplished by detecting the beginning and end of the audio recording and recording the tone so that it coincides with the audio signal. That is the tone is present only while there is an audio signal.

FIG. 6 is a schematic diagram of an interface unit 200 connecting the stereo sound recorder to circuit board CB. Preferably, unit 200 has an edge connector for receiving board CB. Thereby, a connection is effected between correspondingly numbered connections on board CB and interface 200. As an input, unit 200 has a stereo jack 210, into which there can be inserted a conventional stereo plug providing a stereo signal from the stereo recorder. In this example, the tip 212 of the stereo plug carries the channel with the tone recording and the ring 214 of the plug carries the audio recording. The tone signal is received by a tone detector 220, which is constructed to be sensitive to the frequency of the tone. This produces a voltage between connections I3 and I4 which causes circuit 112 to record. That voltage is present while the tone is present, and the tone is present only during the presence of the audio signal. The audio signal at the ring 214 is applied to connection I2 through a filter 230, and connection I2 is connected to the microphone input of circuit 112. Through the use of interface 200, it is possible to record the audio signal precisely. It is only necessary to connect the board CB and then turn on the audio recording. This is a particularly efficient way to record many circuits 112 with high accuracy in a short time, for example on a production line.

When recording is complete, and board CB can been mounted in a greeting card, and the recorded material may be played back and heard through speaker 122, by depressing pushbutton 120. Preferably, the greeting card has visible indicia overlying and aligned with pushbutton 120 indicating that it must be pressed to play a recorded message. By doing so, the recipient of the greeting card can play the recorded message.

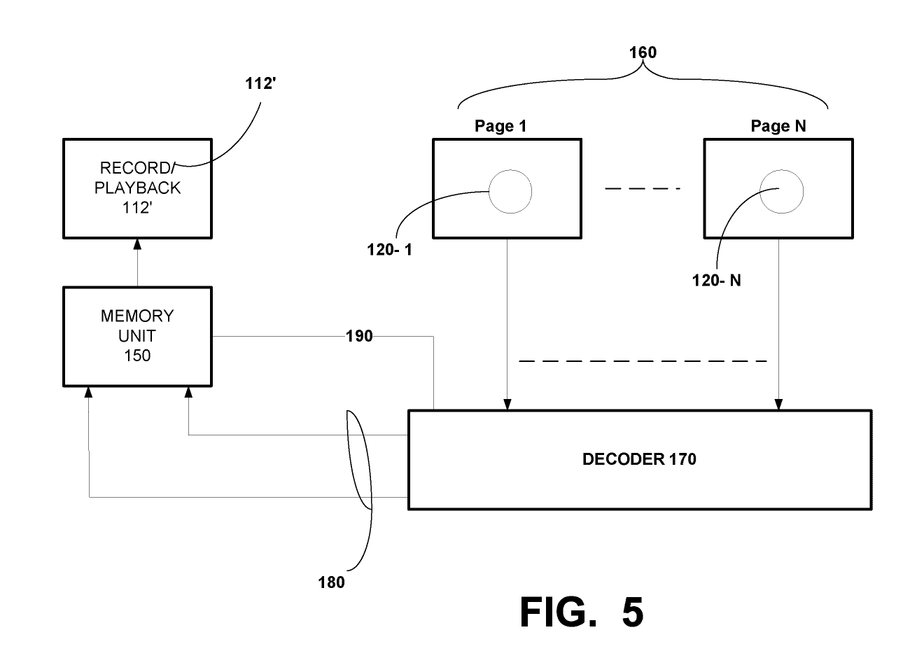

Instead of a greeting card format, a printed image containing circuit 112 to be provided in the form of a talking photograph or a photograph accompanied by audio, or a plurality of them could be combined into a photo album book. Alternatively, as shown in block diagram form in FIG. 5, a single audio playback circuit 112′ could be combined with a memory unit 150 that contains associated audio files. Ahead of time, N audio files could be created and stored in predefined locations in memory unit 150. Each of the N pages of an album 160 is provided with an embedded pushbutton 120-1 . . . 120-N, which are connected to a decoder 170, which has a plurality of outputs connected to memory 150 via leads 180. Decoder 170 is constructed so that when a particular one of pushbuttons 120-1 . . . 120-N is pressed, and addresses produced leads 180 which corresponds to the memory location of the respective, stored audio signal, and the signals produced on lead 193 which causes memory 150 to provide the correct signal to playback circuit 112′. The appropriate audio signal is then sounded.

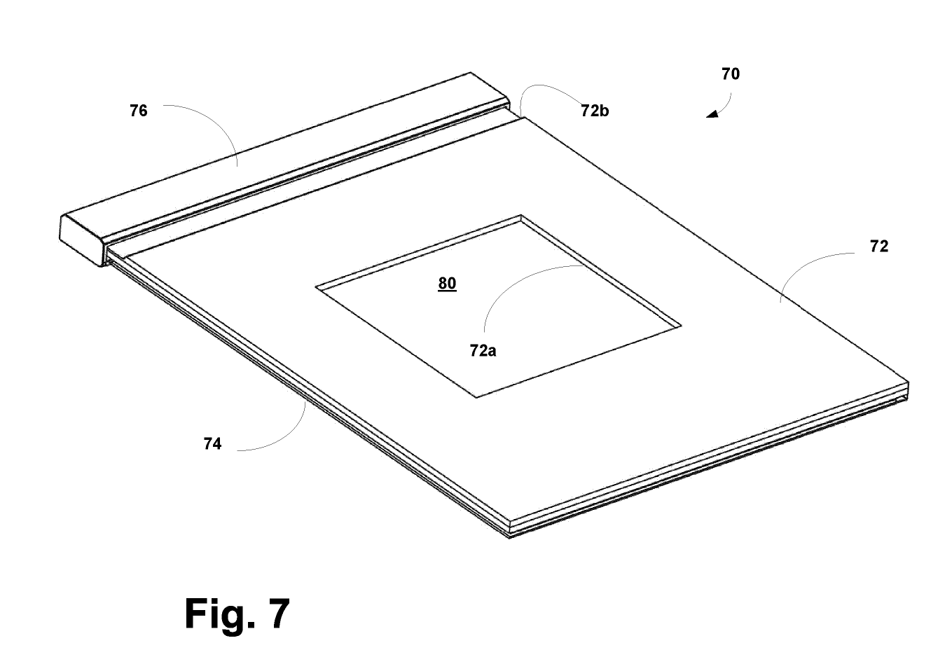

FIG. 7 is a perspective view of a photographic album book 70 embodying the present invention. As described above, this is an album with multiple text, photographs and sound recordings associated with the photographs. In this case, the album 70 is shown closed. The album has heavy front and rear covers 72, 74, made, for example, of board or plastic. Preferably, covers 72, 74 are covered with a decorative fabric, such as velvet or felt. On one side, covers 72, 74 are held together by a binding portion 76.

Cover 72 has a cut-out window 72, which permits the photograph 80 on the first page of the album to be displayed as a form of decoration. Next to the binding portion 76, cover 72 is constructed to have a hinge 72b.

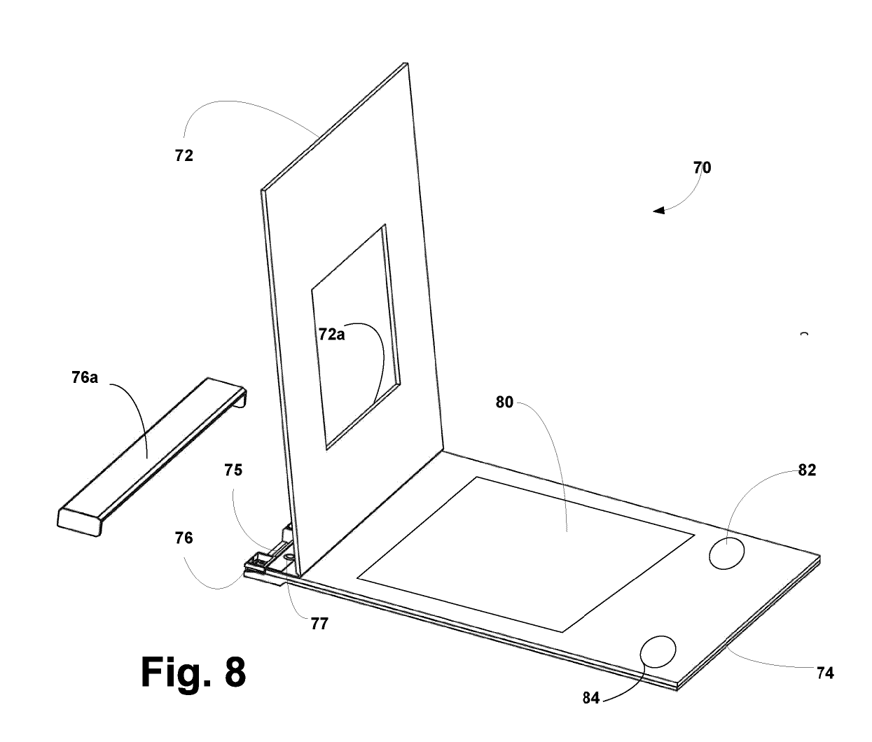

FIG. 8 is a perspective view of the album 70 shown in its open position. Between the covers of 72, 74, the album contains a plurality of pages P with pictures or photographs, possibly including text. In FIG. 8, the photograph 80 on the first page of the album may be seen, which may either be either secured to or imprinted upon the page. In addition, there are two additional, smaller photographs or icons 82, 84, which will be described further below. These also may be imprinted on the page or secured to it.

As may be seen, binding portion 76 has a removable cover 76a. This cover conceals a battery compartment (not shown), an accessible circuit connector 75, and a plurality or rivets, or the like, 77 which hold the album together.

As will be explained further below, cover 74 contains a plurality of touch sensitive areas or electrical switches. The photographs 82, 84, which may be user generated customized icons, are disposed above and in alignment with such photographs is touched, it is sensed by those areas, and electronics hidden inside section 76 are activated. A corresponding sound recording preprogrammed to the touched area, and which is therefore associated with a specific photograph, is then played. For example, photographs 82, 84 might be pictures of individuals and pressing one of those areas plays a voice recording of that individual discussing photograph 80.

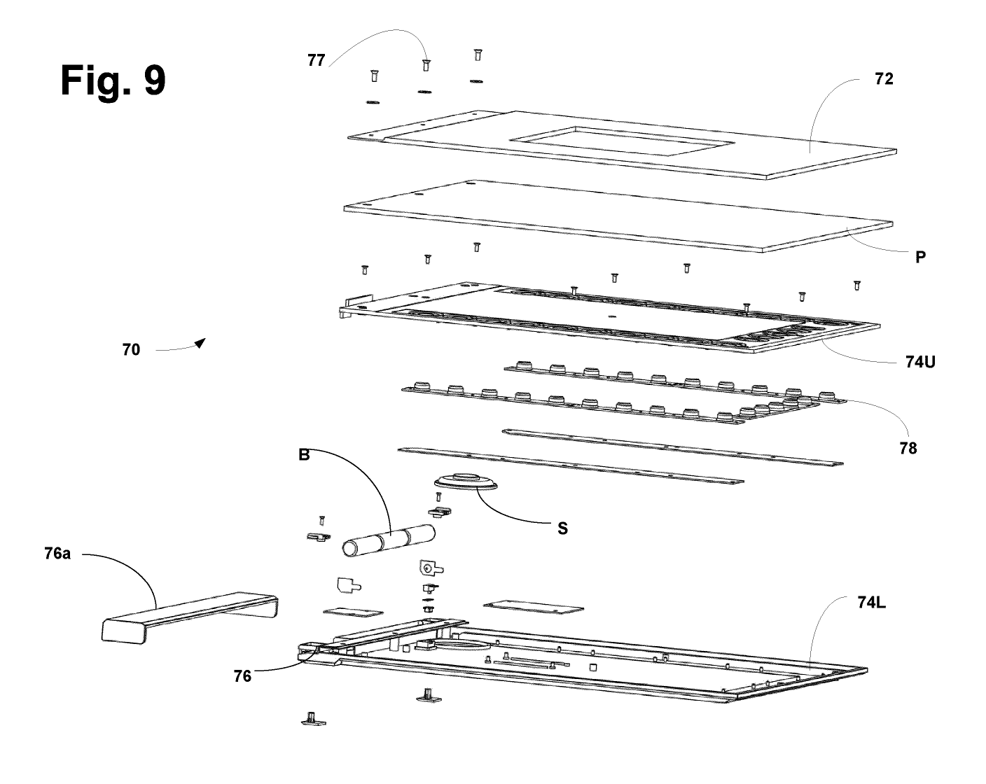

FIG. 9 is an exploded view of the photographic album 70 of FIGS. 7 and 8. In this figure, the interior of portion 76 is shown. As may be seen, portion 76 houses a plurality of batteries B and a speaker S. In addition, the lower cover 74 is made up of upper and lower parts 74U and 74L. Between them, there is provided an array of touch sensitive electrical switches 78 in a predefined arrangement, defining the touch sensitive areas. Between the covers 72, 74, there are a plurality of pages P, each of which may have one or more small pictures, such as pictures or icons 82, 84, indicating the presence of audio for the associated image. When provided on these pages, those pictures are aligned with one of the switches in assembly 78 as explained above, so operation of such a switch could actuate a preprogrammed corresponding recording.

Those skilled in the art will appreciate that the album books of FIGS. 7-9 could be designed and manufactured by any and all of the methods and systems described with respect to FIGS. 1 and 2.

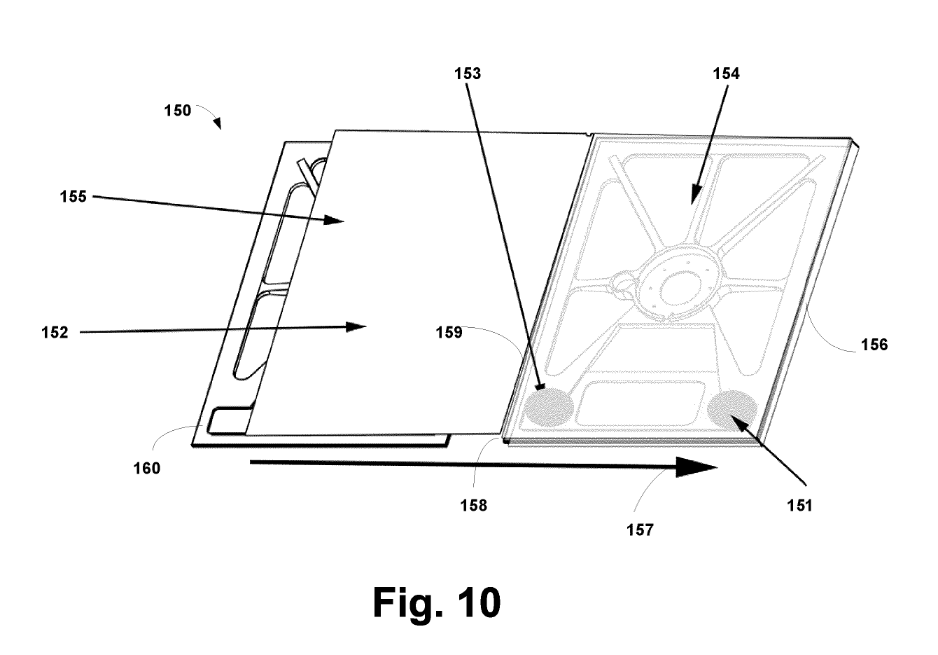

FIG. 10 is a perspective view of a multimedia greeting card 150 embodying the present invention. The card 150 is comprised of three panels 152, 154, 156, preferably made of paper or cardboard. Panels 154 and 156 are secured together at their upper, lower and right hand edges, leaving an opening at their left edges for a pocket 158. Panel 152 then defines a front cover for card 150 and panels 154,156 define a rear cover. A circuit board 160 is inserted into pocket 158 by being moved in the direction of the arrow 157. Panel 152 is joined to panel 154 at a crease line 159, or the like, to permit the panel 152 to open in the manner of a book cover.

In practice panels 152, 154 and 156 could be formed as a single sheet 155. It is contemplated that the entire card 150 could be designed electronically, in which case the sheet 155 comprising panels 152, 154 and 156 would be imprinted prior to assembly on the basis of the electronic files. For example, photographs could be imprinted on both faces of panel 152 and on the visible face of panel 154 in FIG. 10. It would also be possible to imprint a small photograph or graphic or icon 151 for a reason to be explained below, and a removable the sticker 153 could also be provided, for a reason to be explained below.

The sheet 155 comprising panels 152, 154 and 156 could then be assembled by folding panel 156 under panel 154 and securing the upper and lower edges of panels 154 and 156. Sheet 155 is preferably creases at 159 to form a hinge. Board 160 might be prerecorded, in which case pressing on picture 151 will cause board 160 to play back prerecorded content. As will be explained below, board 160 has a touch sensitive playback area which lies under picture 151.

It is also possible for board 160 to be provided in a recordable form. In this case, board 160 has a second touch sensitive area which lies under sticker 153. Board 160 is constructed so as to be recordable when sticker 153 and picture 154 are pressed simultaneously and so as to playback the recorded content when only picture 151 is pressed. Once board 160 has been recorded, sticker 153 may be removed, making it unlikely that recording over a previously recorded content will occur.

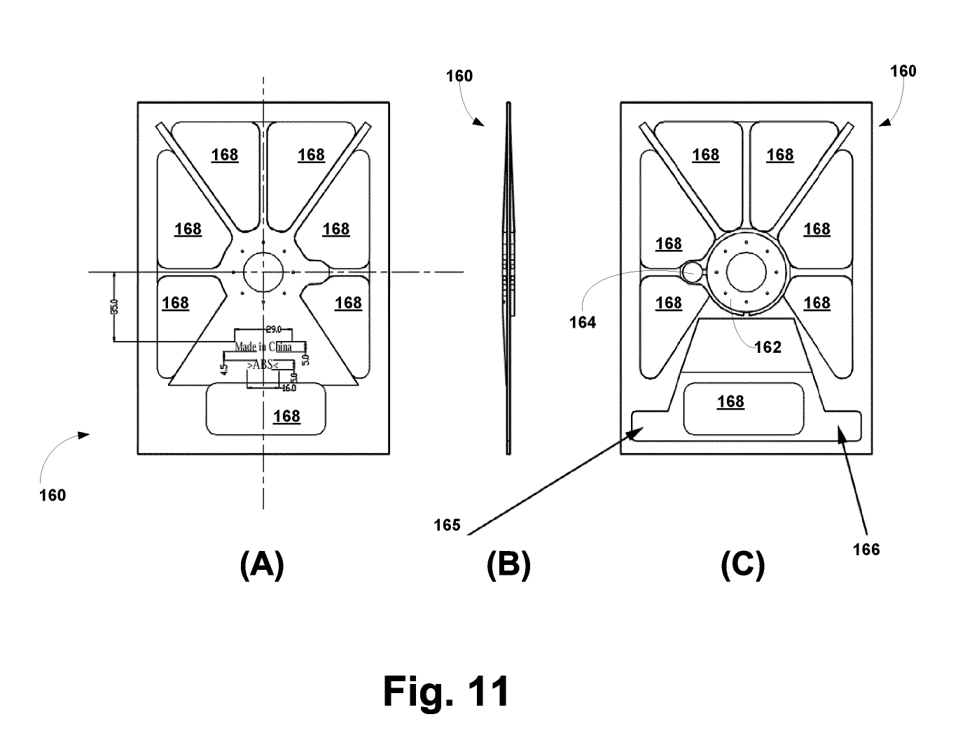

FIGS. 11 (A), (B), and (C) are rear, side, and front views, respectively, of circuit board 160. Preferably, board 160 is made of relatively thin card of plastic material, in which is embedded all of the electronics necessary to provide a record and playback function including batteries. In the center of board 160, there are surface mounted a speaker 162 and a microphone 164. Board 160 is also constructed to have touch sensitive areas 165, 166, which function has electrical switches or pushbuttons. Applying pressure in area 166 will cause board 160 to go into a playback mode and applying pressure to areas 165 and 166 simultaneously will cause board 160 to go into a sound recording mode. Board 160 is preferably formed with cut-out areas 168 in order to minimize the amount of plastic material used and, therefore, the weight of board 160.

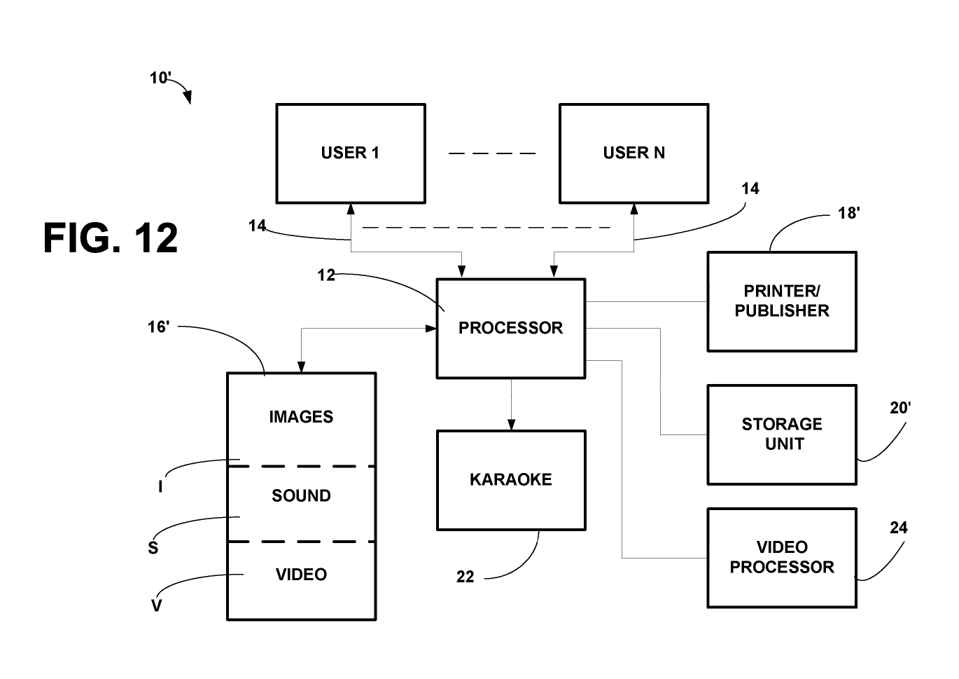

FIG. 12 is schematic block diagram illustrating an exemplary system 10′ for generating a multimedia keepsake with multiple pages, such as an album. It is contemplated that system 10′ may be an online system, or it may be a kiosk at some central location. System 10′ includes a processor 12 which accommodates a plurality of users U₁ . . . Uₙ, each connected to processor 12 via a communication link 14. The users communicate over links 14 via a communication device, such as a smart phone, a PDA, a terminal or a computer.

In an online system, processor 12 could be a server and the users' communication devices could be clients communicating with the server over a network, such as the Internet. Each communication link 14 could therefore be a fairly complex combination of communication media. In a kiosk, system 10′ could be far simpler, with the uses communicating with processor 12 via simple terminals connected, for example, by a wire connection. In some instances, a simplified version of the system may be present at the site of a users computer system.

In storage 16′, processor 12 has access to a collection of images I, a collection of sounds S and a collection of videos V. The collections of images I, and videos V may include images and videos uploaded to the server by a user, such as personal sounds, photographs or videos, and the collection of sounds S may include music and/or voice recordings (e.g. a personal message) uploaded by a user. It is contemplated that a user will be permitted to create a private section in each of collection I,S and V.

Processor 12 also controls a printer/publisher unit 18′ and a storage unit 20′. For example, the keepsake may be an album comprising a plurality of pages in the form of a flat substrate, upon which one or more images and/or a printed message may be present. For example, it may be a page with a photograph and strategically placed icon(s), as explained above, with finger pressure on the icon playing recorded audio. Printers within unit 18′ would then print pages with appropriate images and icons thereon. Unit 18′ is also a publishing unit, in that it may generate publication data which associates the visible information on pages with corresponding recorded audio for proper playback by the keepsake. This data would eventually be stored in electronics within the keepsake to control audio playback in relationship to pages (the control function described in FIG. 5). Storage unit 20′ receives a complete set of data for an album and produces programmed electronics to be inserted in the album. The electronics would include the decoding function of decoder 170 and the audio information that goes with each page. In practice, the pages could be printed in unit 18′ and the electronics programmed in unit 20′. The completed album could then be assembled and delivered to the customer, or the parts could be delivered for assembly by the customer.

An additional possibility is that a karaoke facility 22 be provided which would permit the user to sing a song and be accompanied by prerecorded music. In addition, the user may be offered the opportunity to have the message recorded by a professional, for example a celebrity or a cartoon character. In this case, the user could type in his message and the recorded voice message would be created through a text-to-speech processor in the voice of the professional. Alternately, pre-recorded phrases in a professional's voice could be assembled into a customized message based upon the user's responses to a series of queries. This could also be accomplished by making use of concatenated text-to-speech technology (see www.varitalk.com).

In a kiosk, units 18′ and 20′ would typically be in close proximity to processor 12. A user, working at a terminal, could design and compose the keepsake, and record voice messages and music. The album pages are then printed by unit 18′ and, in unit 20′, the electronics are recorded and dispensed. The keepsake is then completed by assembling the pages to the album and installing the electronics. Alternately, the order for a keepsake could merely be created at a kiosk and then forwarded to a fully equipped fulfillment center for manufacture of the keepsake. The completed keepsake could then be delivered to the kiosk for pickup by the user or shipped to the user's home. As a further alternative, a user could design and compose the keepsake online as explained below and store all the information in a storage location accessible to processor 12. Subsequently, he could access that information from a kiosk, which also has access to the storage location, and complete the greeting card at the kiosk.

It is also contemplated that a user could be provided with specialized software for his computer or at a website (see www.mypublisher.com and www.shutterfly.com). Such software guides the user through the product design process, creating appropriate data files in the process. Those files are then transmitted to a fulfillment center for manufacture of the keepsake.

In an online system, a user may be remote and may even be communicating with processor 12 wirelessly. Under these circumstances, information representing the keepsake and the recorded sound information could be stored in a storage location accessible to processor 12. The units 18′ and 20′ could also be remote from processor 12 and printing of the pages and programming of the electronics could take place at a fulfillment center and then be mailed or delivered to the recipient.

Alternately, with either the online system or a kiosk, the gift giver may wish to record one or more messages in the privacy of his home or to have a message recorded by another person. In this case, all the information relating to the album could be stored in association with an identification code. The gift giver or other person could then call the processor 12 by telephone or online and record a message. During the assembly of an album, which may extend over days or longer, all the persons who are to provide recordings are notified via e-mail or other method and provided instructions on how to record a message. Those skilled in the art will appreciate that the users 1 . . . N in FIG. 12 need not be a gift giver, but can also be third parties. On the other hand, system 10′ permits an album to be created as a collaborative effort, possibly by individuals separated by great distances.

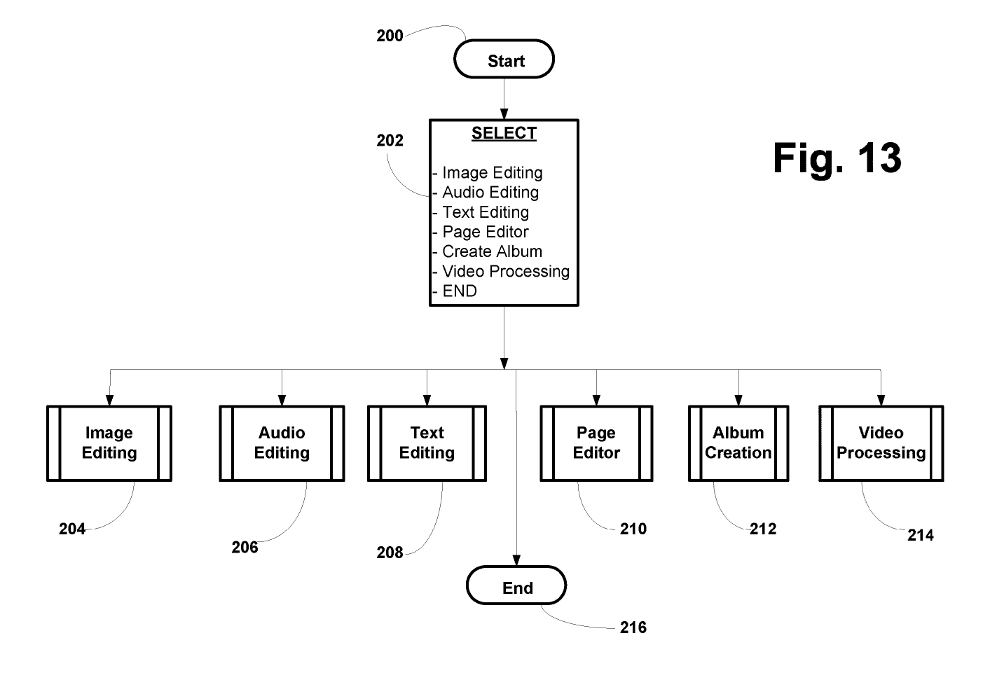

FIG. 13 is a functional block diagram illustrating the top level of operation of system 10′. Operation starts at block 200, with the user being invited to make a selection of a desired operation at block 202, for example from a menu. The available processes are: imaging editing, audio editing; text editing; page editing; create album; video processing; and END. When the user makes a selection, control transfers to the corresponding one of blocks 204-216. Should any of blocks 204-214 be selected, control will return to block 202 after completion of the corresponding process, in order to permit the user to make further selections. Should the users select END, the process will end at block 216.

System 10′ offers full image, audio and text editing capabilities. Image and audio files can come from many sources including the hard drive on the user's computer, a PDA or telephone, or an audio/image player. It will be appreciated that images and audio can be accessed separately, or an image can be provided with an embedded audio, for example embedded in metadata of the image. A user will also be able to provide a voice message from his computer, from a telephone, or any other type of device. The user will also be able to record a song, making use of the karaoke subsystem 22. Basically, a user can acquire images and audio from any online or other source and store them in his personal library in storage unit 16′. As will be explained further below, video processer 24 provides full video processing capability at block 214. This will include the ability to extract images and audio from a video stored in storage 16′. Text editing available in block 208 permits the user to create text for inclusion in the album. It is contemplated that images, audio and text selected for inclusion in an album will be stored in working storage associated with that album and available to processor 12.

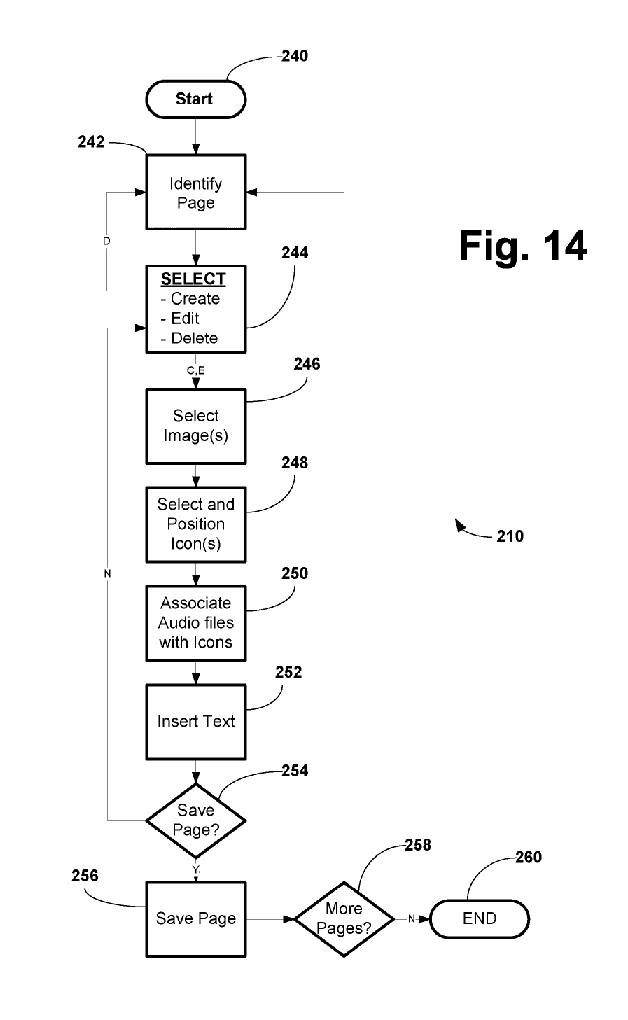

The page editor program 210 allows creation, editing and deletion of pages of the album. FIG. 14. is a functional block diagram illustrating the operation of the page editing process 210. The process begins at block 240, with a page being identified at block 242. At block 244, the user must select whether he wants to create, edit, or delete the identified page. If he selects “delete”, the page is deleted and control reverts to block 242. If the user selects to “create” or “edit” a page, control transfers to block 246, where he may select images for inclusion on the identified page. At this point, he may select images if he is creating a page, or he may select a revised image to replace an existing one, if he is editing a page. Similarly, he may simply skip this step if he is not making any changes to images. At block 248, the user selects icons for inclusions on the page, and he selects the position of each icon. If he does not wish to add or change icons, he may proceed to the next step. At block 250, the user associates audio files with each of the icons. If he does not wish to make new associations or changes, he may proceed to the next step. At block 252 the user may insert text onto the page. He will have the ability to make use of the text editing process 208 to define fonts, styles and colors of text.

At block 254, the user is given the option to save the page. If he decides to do so, control is transferred to block 256. If he does not, control reverts to block 244, permitting the user to edit or delete the page. Assuming the user has decided to save the page, the page is saved at block 256, after in which a test is performed at block 258 to determine whether the user wishes to operate on more pages. If not, the process ends at block 260. If the user decides to work on more pages, control transfers to block 242, where the user may select the next page upon on which to operate.

Those skilled in the art will appreciate that during the performance of the entire process illustrated in FIG. 14, processor 12 will be creating files saving the definitions of the different pages and saving them in working storage associated with the album that the operator is working on.

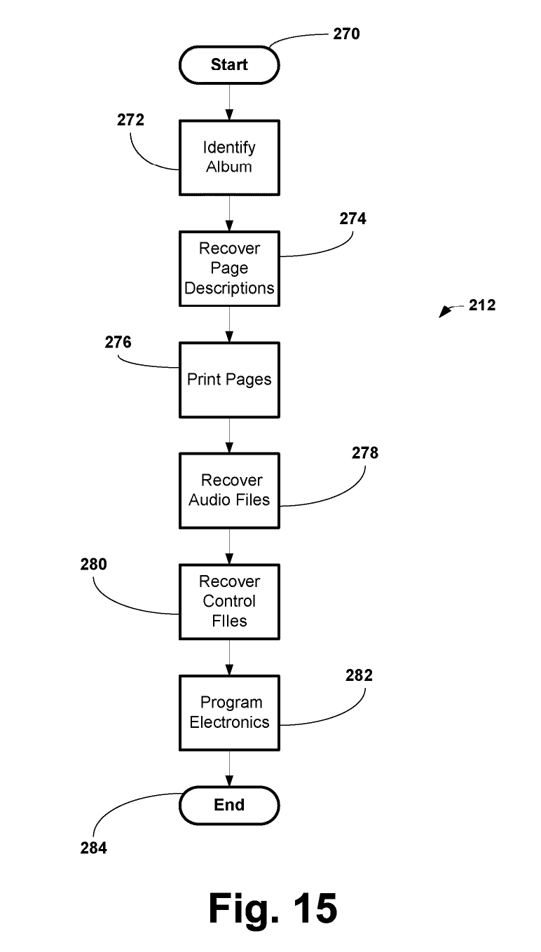

FIG. 15 is a functional block diagram illustrating the preferred operation for album creation process 212. The process begins at block 270, with the operator identifying the album being created at block 272. At block 274 the page descriptions for the album pages are recovered from storage. Thereafter, the album pages are printed at block 276 making use of unit 18′. At block 278, the audio files corresponding to the album are recovered from storage, and at block 280 the control files relating icons and corresponding audio files are recovered from storage. At block 282, the electronics corresponding to the album are programmed. The electronics will contain all of the audio files and control files. The control files define the correspondence between an icon and an audio file, so that the correct audio file is played when the icon area is pressed.

Preferably, the album will include all of the electronics for the playback functions and a microprocessor. Therefore, it would only be necessary to program a memory chip containing all of the audio files and control files for use by the microprocessor. The memory chip would also include all of the programming necessary to operate the processor.

As explained above, system 10′ incorporates a video processor with full video editing capability. This includes the ability to extract frames from the video and save them as an image, as well as the ability to select a range of audio from the video sound track and save it as an audio file. Using the editor, an operator could extract images from a video, along with their associated audio and create and album of the type described above which would correspond to the video. For example, if a user had a video of a wedding, he could then create a multimedia album of the same wedding.

However, system 10′ goes well beyond that capability. It includes a program which automatically extracts images representing different scenes of a video, automatically extracts corresponding audio, and saves them as associated files so as to permit the creation of a multimedia album. Technology to perform automatic image extraction from a video is available. For example, Topaz Moment (available at http://www.topazlabs.com) is a software utility which performs such a function. Making use of such a utility, system 10′ creates the necessary files for producing a multimedia album and completes the album.

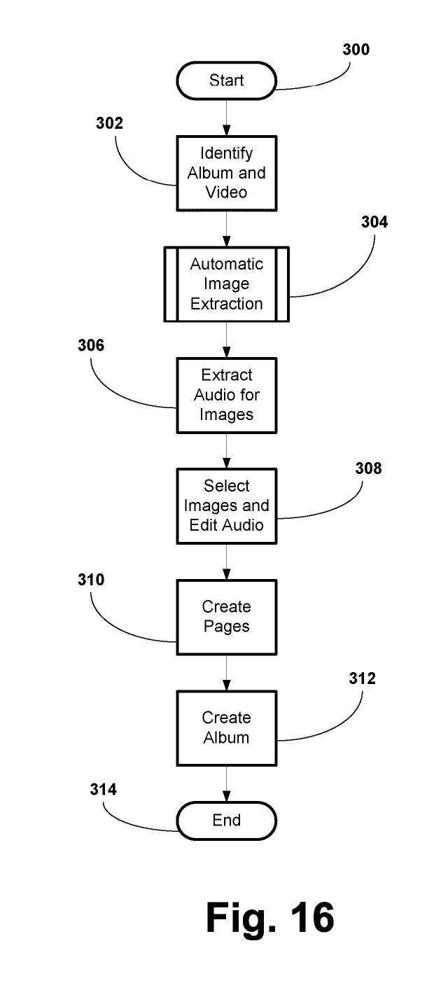

FIG. 16 is a functional block diagram illustrating a preferred method for creating a multimedia album from a recorded video. The process starts at block 300, and at block 302, the user identifies the album to be created and the video to serve as the source of images and audio. An automatic image extraction utility is then run to extract a set of images from the video (block 304). The time location of each image in the video is recorded, at block 306 and use is made of video processor 24 before and after the occurrence to extract a predetermined amount of audio corresponding to the image. The start and stop time of audio extraction are selected to obtain the desired audio with a high degree of probability. For example, the audio processor might automatically extract ten seconds of audio on either side of the frame. Each automatically extracted image and the associated audio are stored in association to each other.

At block 308, use is made of the image editing process 204 to delete those images which the operator does not wish to use, leaving the ones to be included in the album and their associated audio files. At the same time, use may be made of the audio editor module 206 to trim down each audio file so that it includes only the audio desired by the operator.

At block 310, use is made of the page editor module 210 to create the pages of the album. The audio is already stored in association with a corresponding image, so the selection of an image would result in selection of the appropriate audio. It is only necessary to create an icon to enable the audio to be played. At block 312, the album may then be created making use of album creation module 212. The process ends at block 314.

As far as the generation of an album from a video is concerned, it will be appreciated that it could all be performed by a service bureau which is provided with a copy of the video and ships the completed album to the consumer. It would also permit, for example, a wedding videographer to provide a new service by providing wedding video books to the family and guests.

Those skilled in the art will appreciate that system 10′ could be used, not only to produce a physical multimedia album, as described, but also a software album or an album on CD. Programs which produce software albums or slideshows on a computer or storage media, such as CD, are well known. It is only necessary to store each image in association with the corresponding audio, for example a place in the metadata for the image, and the audio will then be played when the images are viewed.

For convenience of description, the various aspects of the invention have been embodied in a multimedia album and its creation. However, it is believed that the invention finds much broader application. For example, it would lend itself readily to the creation of custom, multimedia storybooks for children. A parent could sign onto a website, provide images of a child and/or his pet and information about him. Sound files could also be provided, such as of the child singing or playing an instrument. The site could then generate a customized version of an existing story, inserting the child's name, his picture, a picture of his pet, or information about the child. The story could even be in the voice of the child's favorite storybook or cartoon character, through the use of text-to-speech or concatenation technology.

Furthermore, both the album and card embodiments of the invention represent convenient commercial vehicles. For example, it could be used by a salesman to present a product or by a real estate broker as an introduction and complete presentation of a real estate offering. The album could also provide a self-playing PowerPoint presentation, including a voice over.

Another application of the invention could be as an audio book player. An album could be created with electronics that could be reprogrammed via a USB port on a computer. Files representing album pages, including images, icons and text could be downloaded via a computer and printed locally or mailed to a participant. By re-programming the album and mounting a new set of pages, the user can create a new album. This would make it possible to have a multimedia book-of-the-month club.

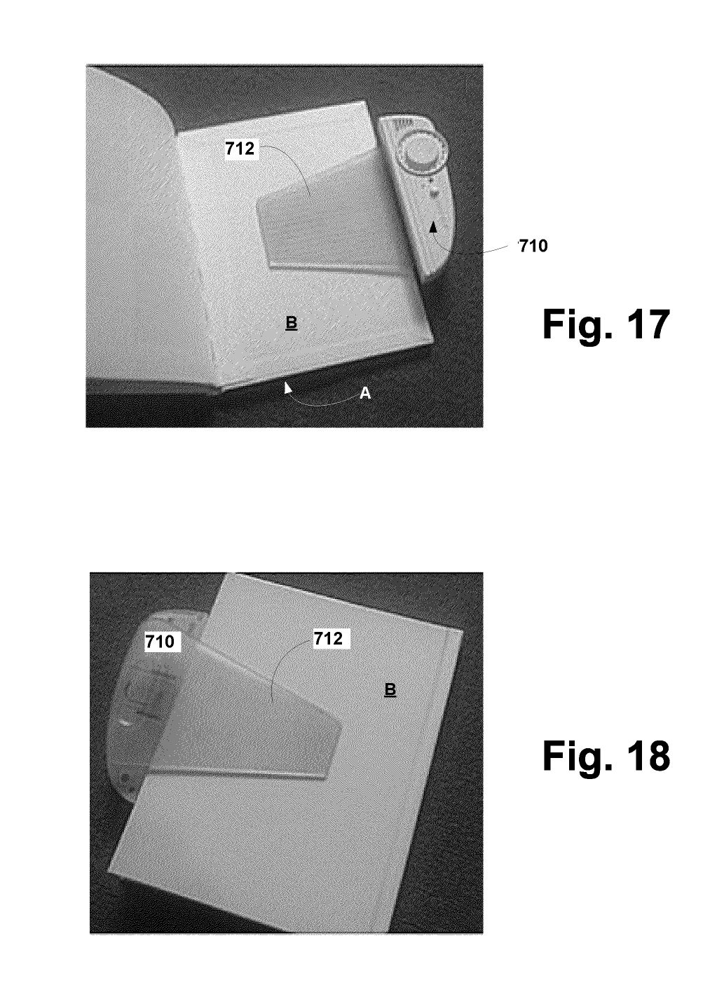

FIG. 17 is a perspective view of an audio unit 710, embodying the invention, in use with an existing book A, and FIG. 18 is a view of the rear of the book A, showing unit 710 attached thereto. The audio unit 710 has a detachable clip 712, by means of which it is mounted to the back cover B of the book A, for use as therewith.

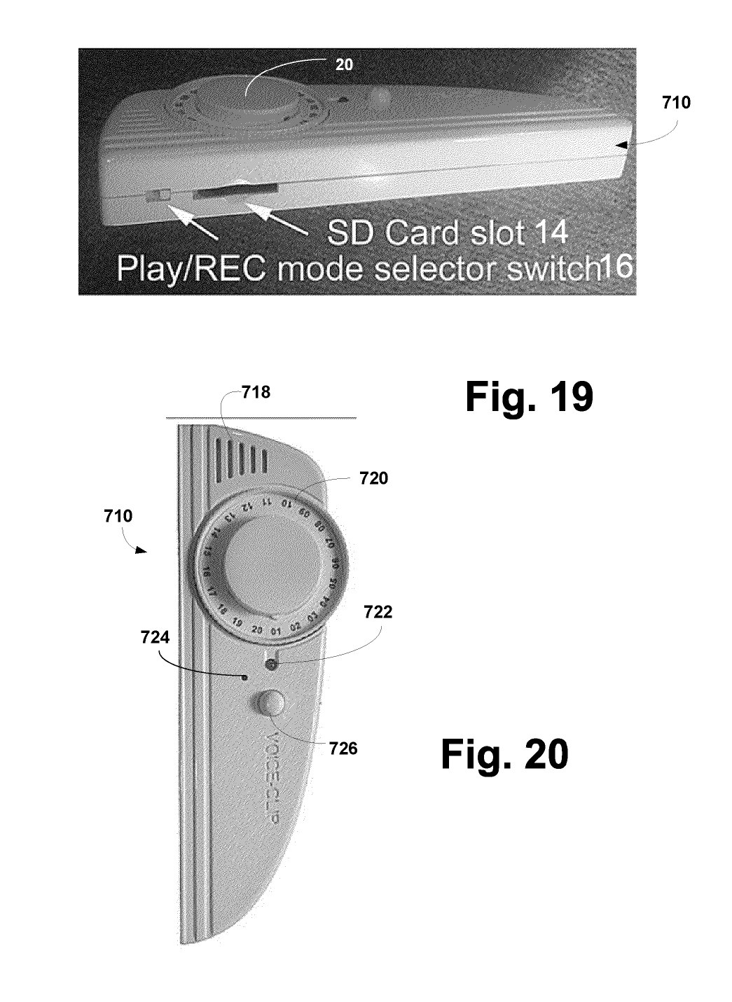

FIG. 19 is a perspective left side view of unit 710, shown with clip 712 detached, and FIG. 20 is a top view thereof, similarly with clip 712 detached. At the side of unit 710 facing book A, there is provided a slot 714 for receiving a memory card 714, preferably a secure digital (SD) card. Alongside card 714, there is provided a two position mode selector switch 716, which switches operation of unit 710 between play and record modes. Unit 710 also includes a speaker 718 for playing back audio, a rotary dial 720 with indicia thereon, a light emitting diode (LED) 722, a microphone 724, and an operating button 726.

It should be appreciated that making clip 712 detachable from unit 710 permits the unit to be used conveniently to record audio apart from the book, for example, on location when photographs are being taken.

In operation, a user may make audio recordings related to book A by adjusting switch 716 to its record position. For example, book A may be an album of vacation photographs, and the user may wish to add a verbal description, music or actual recorded location sounds in association with one or more photographs. Dial 720 includes a number or other indicium identifying each page of book A. So, if the user wishes to record audio related to the photograph on page 10 of the book, he rotates dial 720 to align the indicium “10” with LED 722. The user may then make an audio recording by pressing button 724 and speaking (or providing other audio input) into microphone 726. If there is a previous audio recording relative to “10”, the user will receive an audible warning and must press button 724 again to record over the previous recording. In this manner, the user is able to make an audio recording in association with each page of book A. Alternatively, the user may create a notation on any page of the book by writing a number on any page corresponding to the number on the dial associated with a particular audio recording.

With switch 716 in its play position, the user may rotate dial 720 to select a particular page of book A and, upon pressing button 726, he will hear a playback of audio previously recorded relative to the selected page.

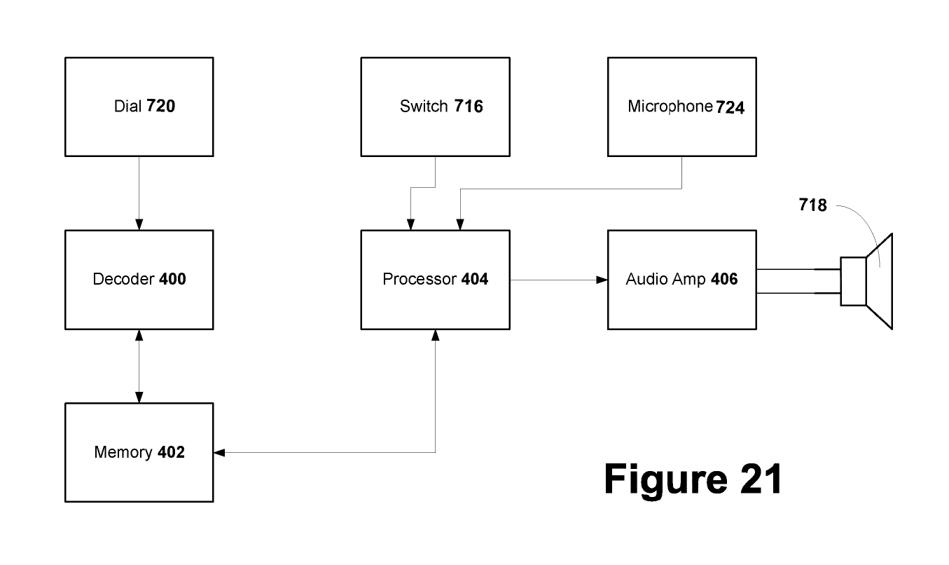

FIG. 21 is a block diagram illustrating the electronic structure of unit 710. Dial 720 is connected to a Decoder 400, which senses the position of the dial and applies a related digital address to Memory 402. The digital address is applied to a processor 404, which also is controlled by switch 716 and also receives a signal from microphone 726. Processor 404 outputs an audio signal to an audio amplifier 406, which drives speaker 718.

Memory 402 includes the memory card in slot 714, containing messages recorded by the user, as well as read only memory (ROM) which includes control code for processor 404 and any messages associated with operation of unit 710 (e.g. the warning message before overwriting a previously recorded memory area).

In addition to controlling unit 710, processor 404 includes an mp3 encoder/decoder. However, those skilled in the art will appreciate that processor 404 could do any other kind of digital encoding of audio. When switch 716 is in the record position and button 726 is operated as described previously, processor 404 encodes the audio received from microphone 724 into an mp3 file and saves that file at the memory address indicated by decoder 400. On the other hand, if switch 716 is in the play position, processor 404 reads the mp3 file stored at the memory address indicated by decoder 400 and decodes it from mp3 format into an audio signal. This audio signal is applied to speaker 718 through audio amplifier 406, permitting the user to hear the recorded audio.

Those skilled in the art will appreciate that the use of dial 720 is a convenient and simple device provided for the user. It would, alternatively be possible to provide a small keypad and display, permitting the user to key in page numbers. Alternatively, a display may be included which indicates file numbers as the user rotates the dial.

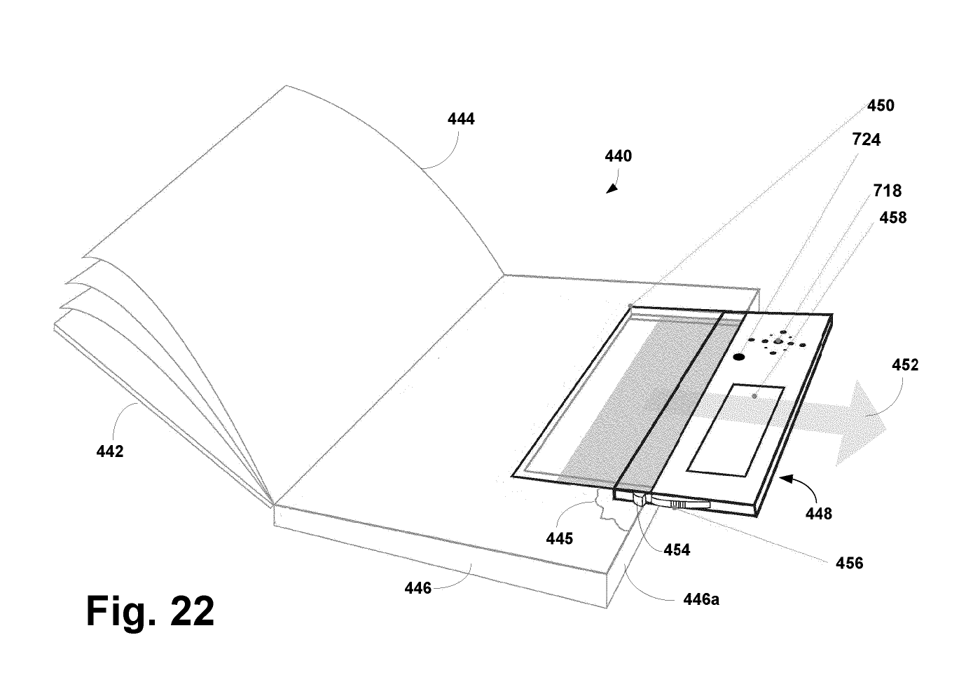

FIG. 22 is a perspective view of a book unit 440 embodying the present invention, wherein a portion 441 is shown cut out to illustrated internal details. Unit 440 broadly comprises a front cover 442, a plurality of pages 444 containing the content of the book, a rear cover a portion 446 and an audio unit 448 housed in rear cover portion 446. Audio unit 448 is mounted within a recessed channel 450 formed in rear cover 446. It may therefore be slid within channel 450, as represented by the arrow 452. However, unit 448 may not be removed from the rear cover 446, as it contains a protruding stop 454 which engages a side wall 446a of rear cover 446 from within, preventing withdrawal of unit 448.

Stop 454 is formed together with an actuator 456, which may be pressed inwardly, carrying stop 454 with it. Actuator 456 is spring biased outwardly, causing stop 454 to prevent removal of unit 448 from rear cover 446. However, upon the application of sufficient force to actuator 456 to overcome its spring loading, stop 454 is withdrawn inwardly, and unit 448 may then be removed from rear cover 446.

Audio unit 448 also includes a speaker 718 and a microphone 724, as was the case with audio unit 710. There is also provided a membrane keypad 458. As was the case with audio unit 710, audio unit 448 contain stored audio corresponding to different ones of pages 444, and keypad 458 includes numerical keys to select recordings corresponding to different pages. Keypad 458 also includes keys to select record and play modes and a key corresponding to button 724 of audio unit 710. Any visual signals provided by audio unit 710 are, instead, provided in the form of audible tones. Audio unit 448 also has a programming port 460, which permits the unit to be programmed from an external computer by using an appropriate cable. Preferably, unit 448 includes a rechargeable battery (not shown) that provides all power needs. The electronic structure of audio unit 440 would be as represented by the block diagram of FIG. 21.

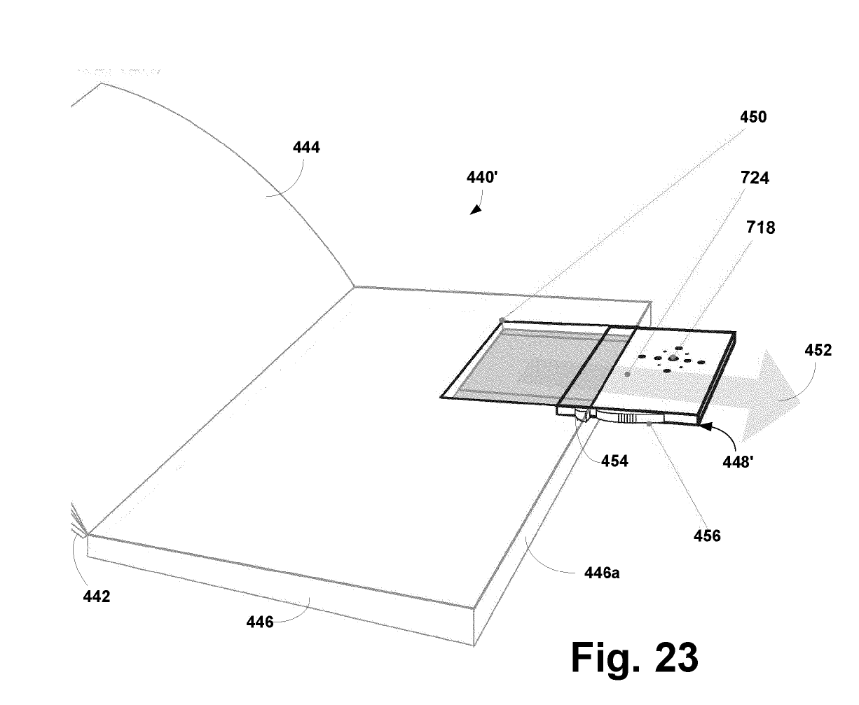

FIG. 23 is a perspective view of a book unit 440′ embodying the present invention. Unit 440′ is substantially the same as unit 440, and similar components are identified with the same reference numerals. Unit 440′ broadly comprises a front cover 442, a plurality of pages 444 containing the content of the book, a rear cover a portion 446 and an audio unit 448′ housed in rear cover portion 446. Except for its form factor, audio unit 448′ may be substantially the same as audio unit 448. In order to provide a more compact unit, certain features have been omitted, but retained elements which are the same are represented by the same reference characters. Unit 448′ is mounted within a recessed channel 450 formed in rear cover 446. It may therefore be slid within channel 450, as represented by the arrow 452. However, unit 448 may not be removed from the rear cover 446, as it contains a protruding stop 454 which engages a side wall 446a of rear cover 446 from within, preventing withdrawal of unit 448.

Stop 454 is formed together with an actuator 456, which may be pressed inwardly, carrying stop 454 with it. Actuator 446 is spring biased outwardly, causing stop 454 to prevent removal of unit 448′ from rear cover 446. However, upon the application of sufficient force to actuator 456 to overcome its spring loading, stop 454 is withdrawn inwardly, and unit 448′ may then be removed from rear cover 446.

Other features of unit 448′ will not be discussed further, as they have been discussed in detail with reference to unit 448.

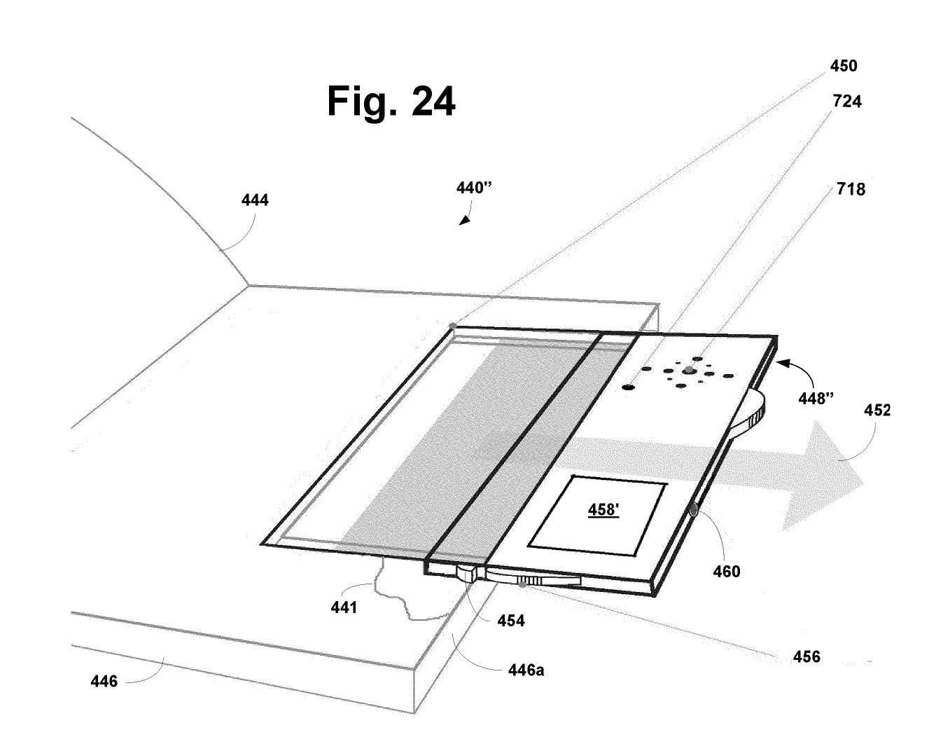

FIG. 24 is a perspective view of a book unit 440″ embodying the present invention, wherein a portion 441 is shown cut out to illustrated internal details. Unit 440″ is substantially similar to unit 440, and similar components are identified with the same reference numerals. Unit 440″ broadly comprises a front cover 442, eight a plurality of pages 444 containing the content of the book, a rear cover a portion 446 and an audio unit 448″ housed in rear cover portion 446. Audio unit 448″ is substantially similar to audio unit 448, and corresponding elements are represented by the same reference characters. Unit 448″ is mounted within a recessed channel 450 formed in rear cover 446. It may therefore be slid within channel 450, as represented by the arrow 452. However, unit 448 may not be removed from the rear cover 446, as it contains a protruding stop 454 which engages a side wall 446a of rear cover 446 from within, preventing withdrawal of unit 448.

Stop 454 is formed together with an actuator 456, which may be pressed inwardly, carrying stop 454 with it. Actuator 446 is spring biased outwardly, causing stop 454 to prevent removal of unit 448″ from rear cover 446. However, upon the application of sufficient force to actuator 456 to overcome its spring loading, stop 454 is withdrawn inwardly, and unit 448″ may then be removed from rear cover 446.

Audio unit 448″ has a multi-file selector 462 which operates in a manner similar to selector 720 in FIG. 20, permitting selection of files for playback and recording. Unit 448″ also includes a membrane keypad 458′, which is similar to keypad 458. However, with file selection being done via selector 462, keypad 458″ need not have numeric keys for file selection. Keypad 458″ would include keys to select record and play modes and a key corresponding to button 724 of audio unit 710. Any visual signals provided by audio unit 710 are, instead, provided in the form of audible tones. The electronic structure of audio unit 400 would be as represented by the block diagram of FIG. 21.

Audio unit 448″ has many components which are essentially the same as corresponding components in audio unit 448 and operate in essentially the same manner. These have been indicated with the same reference characters as used in FIG. 22 and will not be discussed further.

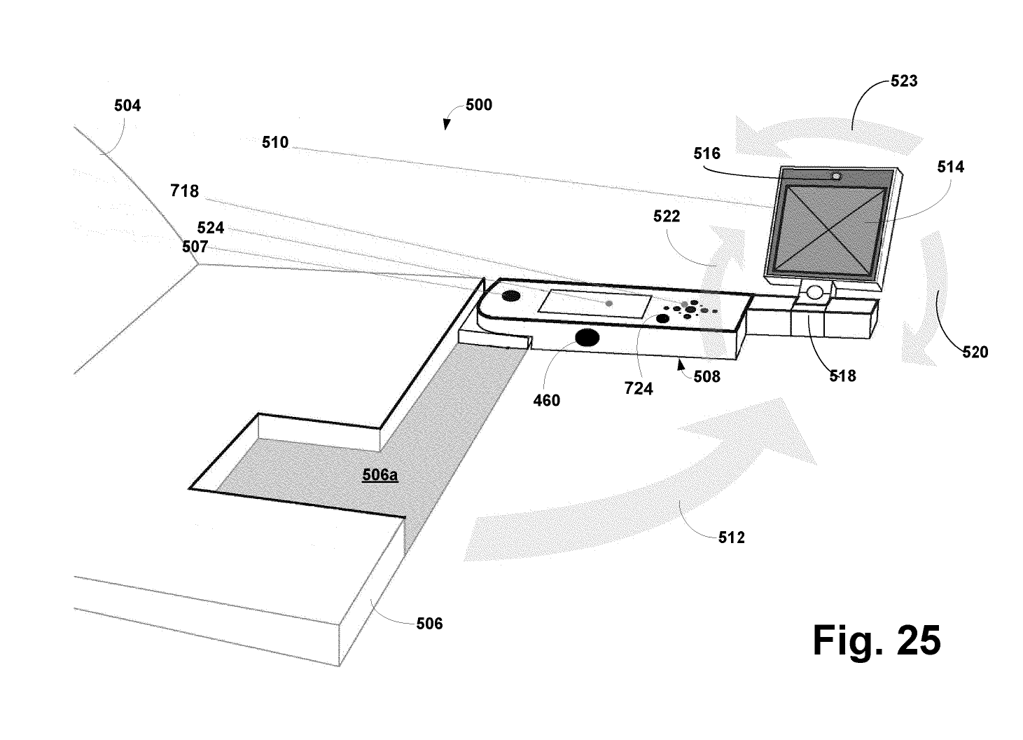

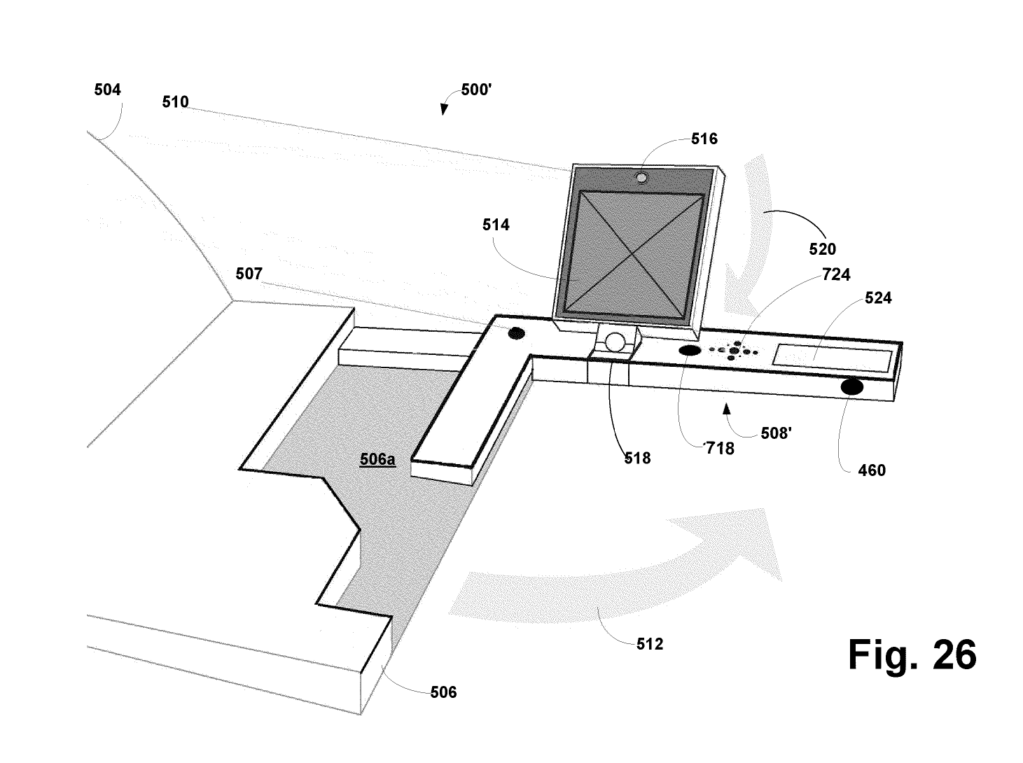

FIG. 25 is a perspective view of a book unit 500 embodying the present invention. Unit 500 broadly comprises a front cover (not shown), a plurality of pages 504 containing the content of the book, a rear cover portion 506 and a multimedia unit 508 housed in rear cover 506. Unit 508 is pivotally mounted at 507 to rear cover 506 so as to fit within a conforming cut-out space 506a. When housed, unit 508 may therefore be pivoted outwardly, as indicted by arrow 512, to its position of use illustrated in FIG. 25.

Unit 508 includes a miniature video display unit 510 with a touchscreen display 514 and a video camera 516. Display 510 is mounted at so as to be pivotable about an elongate axis extending along the length of unit 508 and so as to be rotatable about an axis generally perpendicular to the elongate axis. In FIG. 25, display 510 is shown in its position of use. When stored, it would be pivoted forward, as indicated by arrow 520, so as to be coplanar with the remainder of unit 508. When unit 508 is brought to its position of use by being swung out of space 506a, as represented by arrow 512, display 510 is brought to its position of use by being pivoted as shown by arrow 522. Display 510 may then be rotated for optimum viewing as shown by arrow 524. Upon completion of use, multimedia unit 508 may be returned to storage in rear cover 506 by pivoting display unit 510 forward along arrow 520, then swinging unit 508 downward, opposite to arrow 512, into its storage position within rear cover 506.

Unit 508 also has a speaker 718 and a microphone 724, both of which have been discussed previously with respect to other embodiments. There is also provided a membrane keypad 524. While audio unit 710 contained stored audio files, multimedia unit 508 contains stored multimedia information (e.g. audio, video, still pictures and graphics) corresponding to different ones of pages 504, and keypad 524 includes numerical keys to select recordings corresponding to different pages. Keypad 524 also includes keys to select record and play modes and a key corresponding to button 724 of audio unit 710, as well as keys related to controlling display 510. Any visual signals provided by audio unit 710 may be provided via display 510, or they may be provided in the form of audible tones. Those skilled in the art will appreciate that, instead of using keys on keypad 524, file selection and various control functions could be done via touchscreen 514. Unit 508 also has a programming port 460, which permits the unit to be programmed from an external computer by using an appropriate cable. Preferably, unit 508 includes a rechargeable batter (not shown) that provides all power needs. The electronic structure of audio unit 500 would be as represented by the block diagram of FIG. 21.

FIG. 26 is a perspective view of a book unit 500′ embodying the present invention. Unit 500′ broadly comprises a front cover (not shown), a plurality of pages 504 containing the content of the book, a rear cover a portion 506 and a multimedia unit 508 housed in rear cover 506. Unit 508 is pivotally mounted at 507 to rear cover 506 so as to fit within a conforming cut-out space 506a. When housed, unit 508 may therefore be pivoted outwardly, as indicted by arrow 512, to its position of use illustrated in FIG. 25.

Unit 508′ includes a miniature video display unit 510 with a touchscreen display 514 and a video camera 516. Display 510 is mounted at so as to be pivotable about an elongate axis extending along the length of the portion of unit 508′ which is outside rear cover 506 and so as to be rotatable about an axis generally perpendicular to the elongate axis. In FIG. 26, display 510 is shown in its position of use. When stored, it would be pivoted forward, as indicated by arrow 520, so as to be coplanar with the remainder of unit 508′. When unit 508′ is brought to its position of use by being swung out of space 506a, as represented by arrow 512, display 510 is brought to its position of use by being pivoted as shown by arrow 522. Display 510 may then be rotated for optimum viewing. Upon completion of use, multimedia unit 508′ may be returned to storage in rear cover 506 by pivoting display unit 510 forward, then swinging unit 508 downward, opposite to arrow 512, into its storage position within rear cover 506.

Unit 508′ also has a speaker 718 and a microphone 724, both of which have been discussed previously with respect to other embodiments. There is also provided a membrane keypad 524. As was the case with multimedia unit 508, multimedia unit 508′ contains stored multimedia information (e.g. audio, video, still pictures and graphics) corresponding to different ones of pages 504, and keypad 524 includes numerical keys to select recordings corresponding to different pages. Keypad 524 also includes keys to select record and play modes and a key corresponding to button 724 of audio unit 710, as well as keys related to controlling display 510. Any visual signals of the type provided by audio unit 710 may be provided via display 510, or they may be provided in the form of audible tones. Those skilled in the art will appreciate that, instead of using keys on keypad 524, file selection and various control functions could be done via touchscreen 514. Unit 508 also has a programming port 460, which permits the unit to be programmed from an external computer by using an appropriate cable. Preferably, unit 508 includes a rechargeable batter (not shown) that provides all power needs. The electronic structure of audio unit 500 would be as represented by the block diagram of FIG. 21.

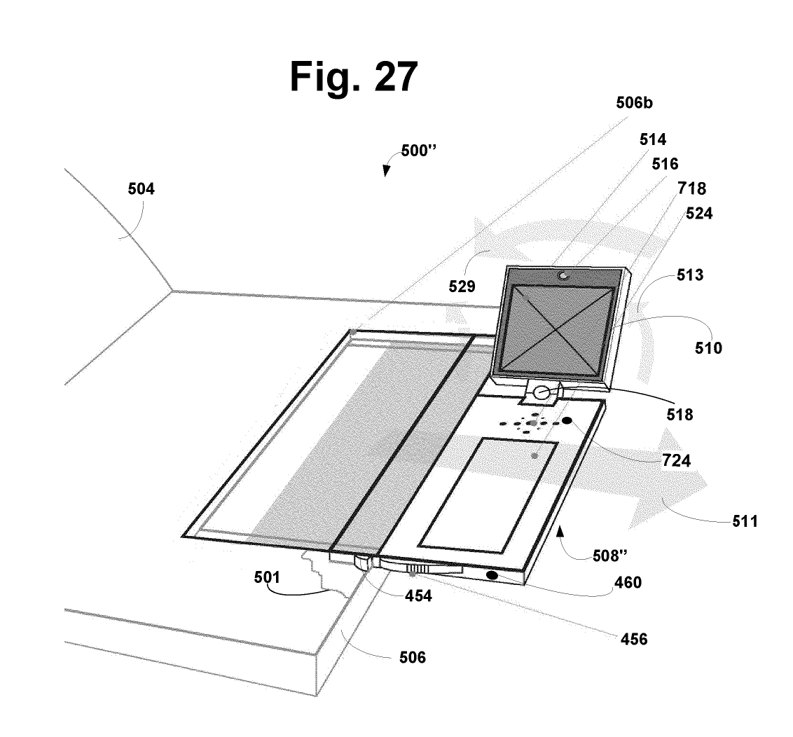

FIG. 27 is a perspective view of a book unit 500″ embodying the present invention, wherein a portion 501 is shown cut out to illustrated internal details. Unit 500″ broadly comprises a front cover (not shown), a plurality of pages 504 containing the content of the book, a rear cover a portion 446 and a multimedia unit 508″ housed in rear cover portion 506. Unit 508″ is mounted within a recessed channel 506b formed in rear cover 506. It may therefore be slid within channel 506b, as represented by the arrow 511. However, unit 508″ may not be removed from the rear cover 506, as it contains a protruding stop 454 which engages a side wall 506c of rear cover 446 from within, preventing withdrawal of unit 448.

Stop 454 is formed together with an actuator 456, which may be pressed inwardly, carrying stop 454 with it. Actuator 456 is spring biased outwardly, causing stop 454 to prevent removal of unit 508″ from rear cover 506. However, upon the application of sufficient force to actuator 456 to overcome its spring loading, stop 454 is withdrawn inwardly, and unit 508″ may then be removed from rear cover 506.

Unit 508″ includes a miniature video display unit 510 with a touchscreen display 514 and a video camera 516. Display 510 is mounted at so as to be pivotable about an elongate axis extending generally perpendicular to the length of unit 508″ and so as to be rotatable about an axis generally perpendicular to the elongate axis. In FIG. 27, display 510 is shown in its position of use. When stored, it would be pivoted rearwardly, as indicated by arrow 513, so as to be coplanar with the remainder of unit 508″. When unit 508″ is brought to its position of use by being withdrawn from back cover 506, as represented by arrow 511, display 510 is brought to its position of use by being pivoted opposite to arrow 522. Display 510 may then be rotated for optimum viewing as shown by arrow 523. Upon completion of use, multimedia unit 508″ may be returned to storage in rear cover 506 by pivoting display unit 510 rearward along arrow 513, then sliding unit 508″ inward, opposite to arrow 511, into its storage position within rear cover 506.

Unit 508′″ also has a speaker 718 and a microphone 724, both of which have been discussed previously with respect to other embodiments. There is also provided a membrane keypad 524. As was the case with multimedia unit 508′, multimedia unit 508′″ contains stored multimedia information (e.g. audio, video, still pictures and graphics) corresponding to different ones of pages 504, and keypad 524 includes numerical keys to select recordings corresponding to different pages. Keypad 524 also includes keys to select record and play modes and a key corresponding to button 724 of audio unit 710, as well as keys related to controlling display 510. Any visual signals of the type provided by audio unit 710 may be provided via display 510, or they may be provided in the form of audible tones. Those skilled in the art will appreciate that, instead of using keys on keypad 524, file selection and various control functions could be done via touchscreen 514. Unit 508′″ also has a programming port 460, which permits the unit to be programmed from an external computer by using an appropriate cable. Preferably, unit 508′″ includes a rechargeable batter (not shown) that provides all power needs. The electronic structure of audio unit 500′″ would be as represented by the block diagram of FIG. 21.

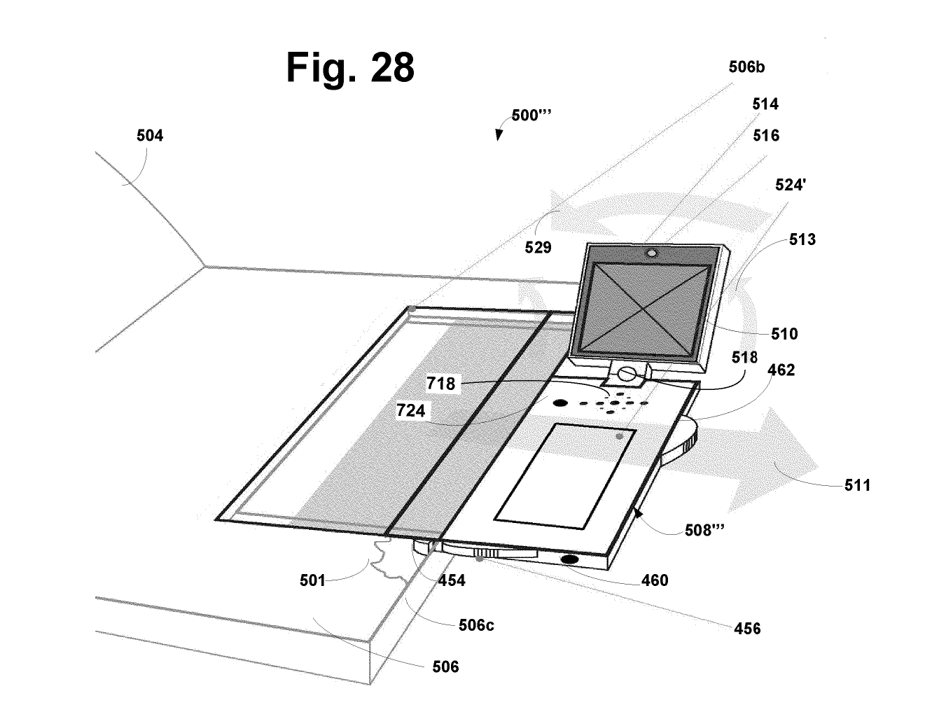

FIG. 28 is a perspective view of a book unit 500′″ embodying the present invention, wherein a portion 501 is shown cut out to illustrated internal details. Unit 500′″ broadly comprises a front cover (not shown), a plurality of pages 504 containing the content of the book, a rear cover a portion 446 and a multimedia unit 508″ housed in rear cover portion 506. Unit 508′″ is mounted within a recessed channel 506b formed in rear cover 506. It may therefore be slid within channel 506b, as represented by the arrow 511. However, unit 508′″ may not be removed from the rear cover 506, as it contains a protruding stop 454 which engages a side wall 506c of rear cover 446 from within, preventing withdrawal of unit 448.

Units 500′″ and 508′″ are very similar to units 500″ and 508″ in construction and operation, and corresponding components have been identified with the same reference characters. Therefore only the differences will be described. The primary differences between book units 500″ and 500′″ is that multimedia units 508″ and 508′″ are different, and that difference resides in the portion of unit 508′″ other than display unit 510, which is identical in units 508″ and 508′″.

Unit 508′″ has a multi-file selector 462 which operates in a manner similar to selector 720 in FIG. 20, permitting selection of files for playback and recording. Unit 508′″ also includes a membrane keypad 524′, which is similar to keypad 524. However, with file selection being done via selector 462, keypad 524′ need not have numeric keys for file selection. Keypad 524′ would include keys to select record and play modes and a key corresponding to button 724 of audio unit 710. Any visual signals provided by audio unit 710 are provided via display 510 or in the form of audible tones. The electronic structure of unit 500′″ would be as represented by the block diagram of FIG. 21.

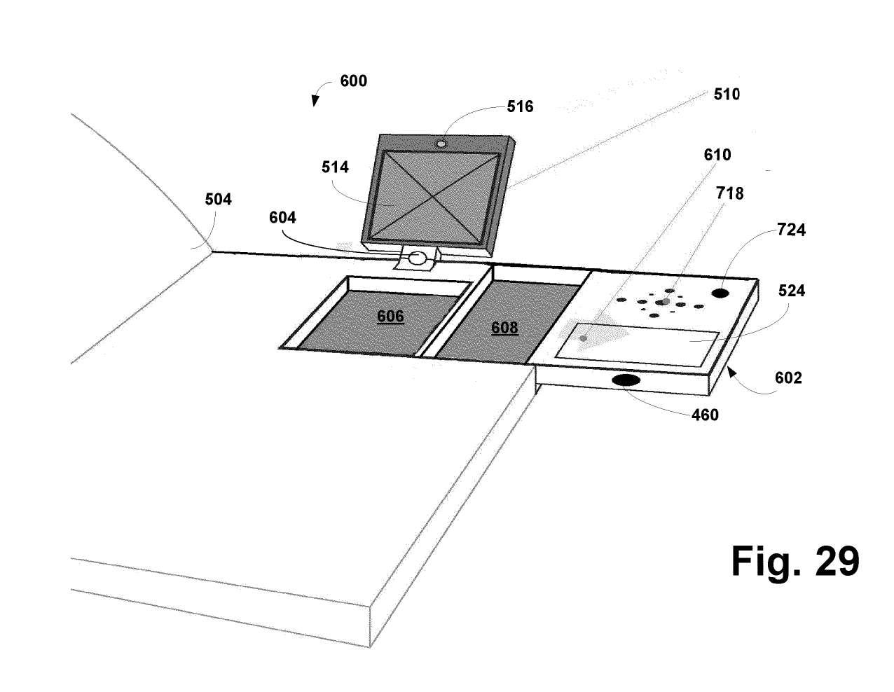

FIG. 29 is a perspective view of a book unit 600 embodying the present invention. Unit 600 broadly comprises a front cover (not shown), a plurality of pages 504 containing the content of the book, a rear cover portion 506, and a miniature video display unit 510 and audio unit 602, both housed in rear cover portion 506.

Display unit 510 has a touchscreen display 514 and a video camera 516. It is essentially identical to display unit 510 of video book unit 500, except it is mounted at 604 to rear cover 506 so as to be pivoted upwardly from a position of storage in a space 606 to its viewing position in shown in FIG. 29. Mounting 604 is also constructed to permit rotation of unit 510 relative to rear cover 506 so that it may be adjusted to any desired viewing angle.

Audio unit 602 is stored in a space 608, but it is mounted so as to be laterally slideable along arrow 610 to its position of use shown in FIG. 29. Unit 610 has a speaker 718 and a microphone 724, both of which have been discussed previously with respect to other embodiments. There is also provided a membrane keypad 524. Since book unit 600 contain stored multimedia files (e.g. audio, video, still pictures and graphics) corresponding to different ones of pages 504, keypad 524 includes numerical keys to select recordings corresponding to different pages. Keypad 524 also includes keys to select record and play modes and a key corresponding to button 724 of audio unit 710, as well as keys related to controlling display 510. Any visual signals provided by audio unit 710 may be provided via display 510, or they may be provided in the form of audible tones. Those skilled in the art will appreciate that, instead of using keys on keypad 524, file selection and various control functions could be done via touchscreen 514. Unit 602 also has a programming port 460, which permits the unit to be programmed from an external computer by using an appropriate cable. Preferably, unit 600 includes a rechargeable batter (not shown) that provides all power needs. The electronic structure of audio unit 500 would be as represented by the block diagram of FIG. 21.

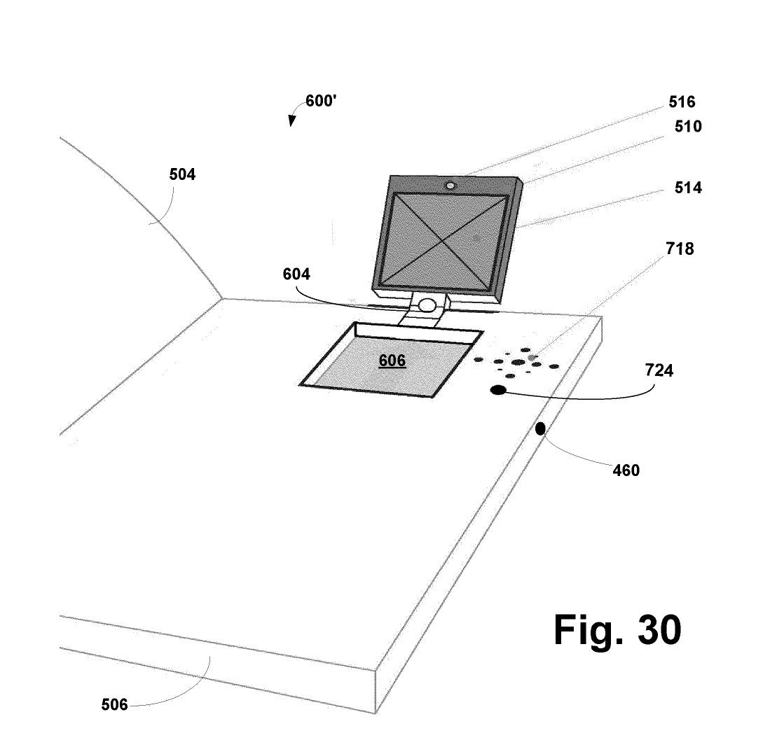

FIG. 30 is a perspective view of a book unit 600′ embodying the present invention. Unit 600′ broadly comprises a front cover (not shown), a plurality of pages 504 containing the content of the book, a rear cover portion 506, and a miniature video display unit 510 and audio unit 602′, both housed in rear cover portion 506. Book unit 600′ is a variant of book unit 600. The two book units are identical, except audio unit 602′ is fixedly built into rear cover 506. Otherwise, the construction and operation of the two embodiments are identical.

Although preferred embodiments of the invention have been disclosed for illustrative purposes, those skilled in the art will appreciate that many additions, substitutions, and modifications are possible without departing from the scope and spirit of the accompanying claims.

I claim:

1. Apparatus for playing recorded audible signals in association with visible media, comprising:
display means exhibiting a plurality of visible media elements, each element showing a unique indicium;
a plurality of storage elements each containing one of the audible signals;
a selector operable by a user to select one of said storage elements, the selector exhibiting one of said unique indicia for a selected storage element; and
a playback device which plays the audible signal contained in the selected storage element.

2. The apparatus of claim 1 wherein the display means is one of a photo album and a book and further comprising a retainer securing the playback device to the display means.

3. The apparatus of claim 1 further comprising a channel therein constructed to receive a portion of the playback device for sliding movement therein so that the device may be selectively housed within the apparatus or moved to protrude therefrom.

4. The apparatus of claim 3 further comprising a stop element limiting the amount of movement of the device within in the channel so as to prevent removal of the device from the apparatus.

5. The apparatus of claim 4 further comprising a release element operable by the user to override the stop element to enable removal of the device from the apparatus.

6. The apparatus of claim 1 wherein the selector includes a rotary dial exhibiting the unique indicia in spaced relationship thereon.

7. The apparatus of claim 1 wherein the selector includes an electronic display utilized to enter indicia.

8. The apparatus of claim 1 further comprising the storage elements being contained in a memory card and further comprising a connector for removably receiving the memory card.

9. The apparatus of claim 1 further comprising:
an audio pick up device;
a encoder responsive to the pick up device and converting the output of the pickup device to a signal storable in a storage element; and
switching means modifying the operation of the apparatus from a record mode in which signals from the encoder are stored and a playback mode in which signals from the storage elements are played by the playback device.

10. Apparatus for playing recorded multimedia signals in association with visible media, comprising:
display means exhibiting a plurality of visible media elements, each element showing a unique indicium;
a plurality of storage elements each containing one of the multimedia signals;
a selector operable by a user to select one of said storage elements, the selector exhibiting one of said unique indicia for a selected storage element; and
a playback device which plays the multimedia signal contained in the selected storage element, the playback device including a visual display component and an audio reproducing component.

11. The apparatus of claim 10 further comprising means mounting at least a component of the playback device to the display means.

12. The apparatus of claim 10 wherein the visual display component is mounted to said apparatus so as to pivot away from a surface thereof into a viewing position outside said apparatus, the visual display component being stored within said apparatus when not pivoted into the viewing position.

13. The apparatus of claim 10 wherein the display means is one of a photo album and a book and further comprising a retainer securing the playback device to the display means.

14. The apparatus of claim 10 further comprising a channel therein constructed to receive a portion of the playback device for sliding movement therein so that the device may be selectively housed within the apparatus or moved to protrude therefrom.

15. The apparatus of claim 14 wherein the visual display component is mounted to said device so as to pivot away from a surface thereof into a viewing position outside said apparatus.

16. The apparatus of claim 14 further comprising a stop element limiting the amount of movement of the device within in the channel so as to prevent removal of the device from the apparatus.

17. The apparatus of claim 16 further comprising a release element operable by the user to override the stop element to enable removal of the device from the apparatus.

18. The apparatus of claim 10 further comprising means mounting said playback device for pivotal movement relative to said apparatus from a stored position within the apparatus to a position of use wherein it protrudes from said apparatus.

19. The apparatus of claim 18 wherein the visual display component is mounted to said device so as to pivot away from a surface thereof into a viewing position outside said apparatus.

20. The apparatus of claim 10 wherein the selector includes a rotary dial exhibiting the unique indicia in spaced relationship thereon.

21. The apparatus of claim 10 wherein the selector includes an electronic display utilized to enter indicia.

22. The apparatus of claim 10 further comprising the storage elements being contained in a memory card and further comprising a connector for removably receiving the memory card.

23. The apparatus of claim 10 further comprising:
an audio pick up device;
a encoder responsive to the pick up device and converting the output of the pickup device to a signal storable in a storage element; and
switching means modifying the operation of the apparatus from a record mode in which signals from the encoder are stored and a playback mode in which signals from the storage elements are played by the audio component playback device.

24. The apparatus of claim 10 further comprising means enabling storage multimedia signals in said storage elements and playback from the storage elements by said visual display component.

25. A method for playing recorded media signals in association with visible media, comprising:
exhibiting a plurality of visible media elements, each element showing a unique indicium;
providing a plurality of storage elements each containing one of the media signals;
associating each storage element with one of said indicia;
exhibiting said unique indicia; and
upon selection of one of said indicia by a user, playing back the media signal stored in the associated storage element.
